(19) United States
(12) Patent Application Publication
(10) Pub. No.: US 2025/0359695 A1
(43) Pub. Date: Nov. 27, 2025

(54) DECORATIVE TREES AND TREE STAND THEREOF

(71) Applicant: Dongguan Polyfilm Plastic Products Company Limited, Dong Guan City (CN)

(72) Inventors: Hylke PAS, Dong Guan City (CN); Simon CHOW, Dong Guan City (CN); Jason LEE, Dong Guan City (CN); Hu Yu SONG, Dong Guan City (CN)

(21) Appl. No.: 19/200,363

(22) Filed: May 6, 2025

Related U.S. Application Data
(63) Continuation of application No. 19/045,762, filed on Feb. 5, 2025, now abandoned.

(30) Foreign Application Priority Data
Feb. 8, 2024 (CN) 202410178373.1

(51) Int. Cl. A47G 33/12; A47G 33/06; A47G 33/08

(52) U.S. Cl. CPC A47G 33/12; A47G 33/06; A47G 33/0863; A47G 2033/0827; A47G 2033/1266

(57) ABSTRACT

The present application relates to a decorative tree and a tree stand thereof. The tree stand includes: a pole assembly configured to support a decoration; a support mechanism fixed on the pole assembly; a support arm hinged to the support mechanism and having a unfolded state and a folded state; a movable base movably disposed on the pole assembly and operably connected to the support arm to drive the support arm to switch between the unfolded state and the folded state; and a first locking mechanism disposed on the movable base and having a locked state and an unlocked state. When in the locked state, the first locking mechanism is capable of locking the support arm in the unfolded state; and when in the unlocked state, the first locking mechanism is capable of unlocking the movable base from the unfolded state. The support arms have the unfolded state and the folded state by hinging the support arm to the support mechanism, so that the overall volume of the tree stand can be changed. In this way, when the tree stand is transferred or stored, the support arms can be maintained in the folded state to reduce the overall volume of the tree stand, thereby saving the space during storage and transportation.

### TECHNICAL FIELD

The present application relates to the technical field of a support structure, and in particular, to a decorative tree and a tree stand thereof.

### BACKGROUND

With the improvement of living standards, people are beginning to focus on the comfort and aesthetics in the working and living environment, the decorations such as artificial decorative trees (e.g., Christmas trees, decorative lighted trees, etc.) will be placed in many places to create an atmosphere, and are indispensable especially in various festivals. The common decorative lighted tree, as an example, usually consists of a light mesh and a tree stand. The light mesh is woven from light strings and cords, and then hanged or wrapped on the tree stand for use. In order to enhance the visual effect of the decorative lighted tree, the overall volume of the tree stand is usually arranged to be larger to play a good decorative effect. However, such arrangement easily leads to problems such as the inconvenience of transferring decorative lighted tree, as well as taking up a large amount of space during storage, and the like.

### SUMMARY

According to various embodiments of the present application, provide a decorative tree and a tree stand thereof are provided.

The present application provides a tree stand, including: a pole assembly configured to support a decoration; a support mechanism fixed on the pole assembly; a support arm hinged to the support mechanism and having a unfolded state and a folded state; a movable base movably disposed on the pole assembly and operably connected to the support arm to drive the support arm to switch between the unfolded state and the folded state; and a first locking mechanism disposed on the movable base and having a locked state and an unlocked state. The support arm is configured to support the decoration. When in the locked state, the first locking mechanism is capable of locking the support arm in the unfolded state; and when in the unlocked state, the first locking mechanism is capable of unlocking the movable base from the unfolded state.

The above tree stand allows the support arm to have the unfolded state and the folded state by hinging the support arm to the support mechanism, so that the overall volume of the tree stand can be changed. In this way, when the tree stand is transferred or stored, the support arm can be maintained in the folded state to reduce the overall volume of the tree stand, thereby saving the space during storage and transportation. In addition, the first locking mechanism can keep the support arm stably in the unfolded state, preventing the support arm from being locked by external force to affect the normal use.

In an embodiment, the pole assembly is provided with a locking recess. The first locking mechanism includes a locking member. The locking member is disposed on the movable base and is movable in a first direction to allow the locking member to have a locked position and an unlocked position. When the support arm is in the unfolded state and the locking member is in the locked position, the locking member extends into the locking recess so that the first locking mechanism is in the locked state; and when the locking member is in the unlocked position, the locking member is withdrawn from the locking recess so that the first locking mechanism is in the unlocked state. The first direction is parallel to a radial direction of the pole assembly.

In an embodiment, the first locking mechanism further includes a first reset member abutting against the locking member to bias the locking member to move from the unlocked position to the locked position.

In an embodiment, the movable base has a through channel and is sleeved on the pole assembly by the through channel; and the movable base further has a receiving cavity and a through hole. The through hole is in communication with the receiving cavity and the through channel. The first reset member is located in the receiving cavity. At least a portion of the locking member is movably disposed in the receiving cavity. The first reset member is located between and respectively abuts against an inner wall of the receiving cavity and the locking member to bias the locking member to move in a direction of extending out of the through hole.

In an embodiment, the movable base includes an upper shell and a lower shell which are connected to each other. The through channel includes a first channel and a second channel. The upper shell includes an inner ring portion provided with the first channel and an outer peripheral portion surrounding the inner ring portion. The outer peripheral portion is connected to the inner ring portion. The receiving cavity is formed between the outer peripheral portion and the inner ring portion. The inner ring portion is provided with the through hole. The lower shell has the second channel.

In an embodiment, a side of the lower shell facing the upper shell is provided with a limiting element. The limiting element includes two limiting guides facing each other. A limiting slot, which extends in the first direction, is formed between the two limiting guides. The first reset member and the locking member are movably disposed and limited in the limiting slot.

In an embodiment, the tree stand further includes an unlocking mechanism including an unlocking member. The unlocking member is operably connected to the locking member to drive the locking member to move from the locked position to the unlocked position. The unlocking member has a first position and a second position. When the unlocking member is in the first position, the locking member is in the locked position; and when the unlocking member is in the second position, the locking member is in the unlocked position.

In an embodiment, the unlocking member is disposed on the movable base and is movable in a second direction. When the unlocking member moves from the first position to the second position, the unlocking member drives the locking member to move from the locked position to the unlocked position in the first direction. The second direction is parallel to the radial direction of the pole assembly but not parallel to the first direction.

In an embodiment, the unlocking mechanism further includes a guide member. The guide member is disposed in the receiving cavity and has a limiting hole corresponding to the through hole. The locking member is movably inserted into the limiting hole and is at least partially limited in the limiting hole. The outer peripheral portion is provided with an operation hole in communication with the receiving cavity. The unlocking member extends through the operation hole and is movably disposed in the receiving cavity. When the unlocking member moves from the first position to the second position in the second direction, the unlocking member pushes the guide member to move in the first direction to drive the locking member to move from the locked position to the unlocked position.

In an embodiment, the locking member is provided with a limiting boss and extends through the limiting hole. The limiting boss is capable of abutting against an opening edge of the limiting hole to limit at least a part of the locking member in the limiting hole.

In an embodiment, the unlocking member includes an operation button and a push arm. The push arm is movably disposed in the receiving cavity. The operation button extends through the operation hole to be connected to the push arm. When moving in the second direction, the operation button drives the push arm to move in the second direction and causes the push arm to abut against the guide member.

In an embodiment, an end of the push arm facing away from the operation button has a driving bevel inclined relative to the second direction. The guide member has a guiding portion configured to abut against the driving bevel to be able to slide along the driving bevel.

In an embodiment, the unlocking mechanism further includes a second reset member. The second reset member is located between and respectively abuts against the operation button and the inner ring portion, to bias the unlocking member to move from the second position to the first position.

In an embodiment, two first locking mechanisms and two guide members are provided. The inner ring portion is provided with two through holes. The unlocking member includes two push arms. The two push arms are movably disposed in the receiving cavity and connected to the operation button. The unlocking member is located between the two first locking mechanisms. One of the push arms abuts against one of the guide members, and another of the push arms abuts against another of the guide members. When the operation button moves in the second direction, the two push arms are simultaneously driven to move in the second direction and to abut against the guide members respectively.

In an embodiment, two unlocking mechanisms are provided. The two unlocking mechanisms and the two first locking mechanisms are alternately disposed in the movable base.

In an embodiment, the lower shell is provided with a limiting guide. The guide member is provided with a sliding guide groove. The limiting guide and the sliding guide groove extend in the first direction and are in sliding engagement with each other.

In an embodiment, the movable base includes a connecting body provided with a first hinged portion. The tree stand further includes a link member. Ends of the link member are hinged to the first hinged portion and the support arm respectively to drive the support arm to switch between the unfolded state and the folded state.

In an embodiment, a plurality of support arms and a plurality of link members are provided. The support mechanism is fixedly sleeved outside the pole assembly. The plurality of support arms are disposed on the support mechanism at equal spacing in a circumferential direction of the support mechanism. The connecting body is provided with a plurality of the first hinged portions disposed at equal spacing in a circumferential direction of the pole assembly. Ends of each link member are hinged to the first hinged portion and the support arm respectively.

In an embodiment, the support mechanism includes a support base and a torsional spring. The support base is provided with a second hinged portion. The support arm is hinged to the second hinged portion. The torsional spring is located between and respectively abuts against the support arm and the second hinged portion, to bias the support arm to switch from the unfolded state to the folded state.

In an embodiment, the tree stand further includes a bottom support mechanism. The bottom support mechanism includes a mounting assembly and a support foot assembly. The mounting assembly is configured to be connected to the pole assembly. The support foot assembly is hinged to the mounting assembly and has an extended state and a collapsed state.

In an embodiment, the mounting assembly includes a mounting cylinder and a sliding sleeve. A mounting channel is formed in the mounting cylinder. The pole assembly is mounted in the mounting channel. The sliding sleeve is movably sleeved outside the mounting cylinder and has a third position and a fourth position. The support foot assembly includes a main support foot and an auxiliary support foot. An outer wall of the sliding sleeve is provided with a third hinged portion. The third hinged portion is configured to be hinged to the main support foot. An outer wall of the mounting cylinder is provided with a fourth hinged portion. Ends of the auxiliary support foot are hinged to the main support foot and the fourth hinged portion respectively. When the sliding sleeve is in the third position, the support foot assembly is in the extended state; and when the sliding sleeve is in the fourth position, the support foot assembly is in the collapsed state.

In an embodiment, the support foot assembly further includes a caster. The caster is disposed at an end of the main support foot away from the third hinged portion.

In an embodiment, at least two support foot assemblies are provided. The at least two support foot assemblies are spaced apart along a circumference of the mounting assembly.

In an embodiment, the pole assembly is a telescopic pole structure and includes at least two slip tubes which have sequentially varying diameters and are sleeved together. A second locking mechanism is disposed between each two of the slip tubes adjacent to each other and sleeved together. The second locking mechanism includes a spring pin assembly and a locking hole. Among the two slip tubes, the locking hole is disposed on an outer slip tube, and the spring pin assembly is disposed on an inner slip tube. The spring pin assembly is capable of being engaged with the locking hole to lock the two slip tubes adjacent to each other and sleeved together.

In an embodiment, among the two slip tubes adjacent to each other and sleeved together, the inner slip tube is provided with a telescoping hole configured to accommodate the spring pin assembly. The spring pin assembly includes a spring pin and a third reset member which abut against each other. The third reset member biases the spring pin to extend out of the telescoping hole to engage the spring pin with the locking hole.

In an embodiment, the pole assembly is a telescopic pole structure and includes at least two slip tubes which have sequentially varying diameters and are sleeved together. A second locking mechanism is disposed between each two of the slip tubes adjacent to each other and sleeved together. The second locking mechanism includes a rotation member and an abutting ring. Among the two of the slip tubes which are adjacent to each other and sleeved together, the rotation member is connected to an end of the inner slip tube and is formed with a limiting groove. A groove bottom of the limiting groove has a convex portion protruding outward. The abutting ring is sleeved on the limiting groove, and a part of the abutting ring projects from the limiting groove to be in contact with the outer slip tube. The inner slip tube drives the rotation member to rotate between an engaged position and an unengaged position. When the rotation member is in the unengaged position, the convex portion is not in contact with the abutting ring, and when the rotation member is rotated to the engaged position, the convex portion pushes against the abutting ring towards a wall of the outer slip tube to increase friction between the abutting ring and the outer slip tube.

In an embodiment, an inner ring wall of the abutting ring is formed with a recessed region and an abutting region. A distance from a ring center of the abutting ring to the recessed region is greater than a distance from the ring center of the abutting ring to the abutting region, and is greater than a distance from the convex portion to an axis of rotation of the rotation member. The distance from the ring center of the abutting ring to the abutting region is greater than or equal to a distance from a bottom wall of the limiting groove to the axis of rotation, and is less than the distance from the convex portion to the axis of rotation of the rotation member. When the two slip tubes adjacent to each other and sleeved together are retractable relative to each other, the convex portion faces the recessed region. When the two slip tubes adjacent to each other and sleeved together are fixed relative to each other, the convex portion faces and abuts against the abutting region.

In an embodiment, the second locking mechanism further includes a limiting sleeve. Among the two slip tubes adjacent to each other and sleeved together, the limiting sleeve is sleeved on an end of the outer slip tube and has a limiting portion. An end of the rotation member away from the inner slip tube has an engaging portion. The engaging portion is stopped by the limiting portion to prevent the inner slip tube from being disengaged from the outer slip tube.

In an embodiment, the tree stand further includes a mounting member detachably connected to the pole assembly. The mounting member is provided with a connecting portion configured to be connected to the decoration.

The present application further provides a decorative tree, including: a decoration and the tree stand as described above. The decoration is supported on the pole assembly and the support arm.

### BRIEF DESCRIPTION OF THE DRAWINGS

The accompanying drawings forming part of the present application are intended to provide further understanding of the present application. Exemplary embodiments of the present application and descriptions thereof are intended to explain the present application, and do not constitute any inappropriate limitation on the present application.

In order to more clearly illustrate the technical solutions in embodiments of the present application, the accompanying drawings used in the description of the embodiments will be briefly introduced below. It is apparent that, the accompanying drawings in the following description are only some embodiments of the present application, and other accompanying drawings can be obtained by those of ordinary skill in the art from the accompanying drawings without creative efforts.

In addition, the accompanying drawings are not drawn to 1:1 scale, and relative sizes of various elements in the accompanying drawings are drawn by way of examples only and not necessarily to true scale. In the drawings:

FIG. 1 is a perspective view of a decorative tree according to an embodiment of the present application, in which the tree stand is in an unfolded state;

FIG. 2 is a side view of the decorative tree shown in FIG. 1;

FIG. 3 is a bottom view of the decorative tree shown in FIG. 1;

FIG. 4 is an exploded view of the decorative tree shown in FIG. 1;

FIG. 5 is an enlarged view of circle A in FIG. 4;

FIG. 6 is a schematic view of a pole assembly of the decorative tree shown in FIG. 1;

FIG. 7 is a cross-sectional view taken along a line U1-U1 in FIG. 6;

FIG. 8 is an enlarged view of circle B in FIG. 7;

FIG. 9 is a perspective view of a decorative tree according to another embodiment of the present application;

FIG. 10 is an exploded view of a pole assembly of the decorative tree shown in FIG. 9;

FIG. 11 is a schematic view of the pole assembly of the decorative tree shown in FIG. 9;

FIG. 12 is a cross-sectional view taken along a line U2-U2 in FIG. 11;

FIG. 13 is a cross-sectional view taken along a line U3-U3 in FIG. 11;

FIG. 14 is a perspective view of a tree stand of the decorative tree shown in FIG. 1, in which the tree stand is in a folded state;

FIG. 15 is a perspective view of a decorative tree according to a yet embodiment of the present application, in which the tree stand is in an unfolded state;

FIG. 16 is a perspective view of the tree stand of the decorative tree shown in FIG. 15, in which the tree stand is in a folded state;

FIG. 17 is a bottom view of the tree stand shown in FIG. 14;

FIG. 18 is a side view of a movable base of the decorative tree shown in FIG. 1, in which the movable base is provided with a first locking mechanism and an unlocking mechanism;

FIG. 19 is a cross-sectional view taken along a line U4-U4 in FIG. 18;

FIG. 20 is a bottom view of the movable base shown in FIG. 18;

FIG. 21 is a cross-sectional view taken along a line U5-U5 in FIG. 20;

FIG. 22 is an exploded view of the movable base in FIG. 18;

FIG. 23 is an enlarged view of circle C in FIG. 19;

FIG. 24 is a perspective view of a bottom support mechanism of the decorative tree shown in FIG. 1, in which a support foot assembly is in a collapsed state;

FIG. 25 is a top view of the bottom support mechanism shown in FIG. 24;

FIG. 26 is a cross-sectional view taken along a line U6-U6 in FIG. 25;

FIG. 27 is a top view of a bottom support mechanism of the decorative tree shown in FIG. 1, in which a support foot assembly is in an extended state;

FIG. 28 is a cross-sectional view taken along a line U7-U7 in FIG. 27; and

FIG. 29 is an exploded view of the bottom support mechanism in FIG. 24.

Illustration for reference signs:

1000: decorative tree, 10: tree stand, 30: decoration, 301: light string, 302: cord, 110: pole assembly, 111: slip tube, 101: telescoping hole, 102: locking recess, 112: mounting base, 1121: mounting groove, 120: support mechanism, 121: support base, 1211: second hinged portion, 122: torsional spring, 130: support arm, 140: movable base, 141: through channel, 1411: first channel, 1412: second channel, 142: receiving cavity, 143: through hole, 144: upper shell, 1441: inner ring portion, 1442: outer peripheral portion, 1444: first avoidance groove, 1445: limiting post, 146: limiting element, 1461: limiting guide, 1462: limiting slot, 147: operation hole, 148: connecting body, 1481: first hinged portion, 1482: first insertion groove, 149: resisting member, 1491: circular sleeve, 1492: connecting pin, 150: first locking mechanism, 151: locking member, 152: first reset member, 153: limiting boss, 160: unlocking mechanism, 161: unlocking member, 1611: operation button, 1612: push arm, 1613: driving bevel, 162: guide member, 1621: limiting hole, 1622: guiding portion, 1623: sliding guide groove, 163: second reset member, 170: link member, 180: bottom support mechanism, 181: mounting assembly, 1811: mounting cylinder, 18111: first cylinder, 18112: second cylinder, 1812: sliding sleeve, 1813: mounting channel, 1814: third hinged portion, 1815: fourth hinged portion, 1816: second avoidance groove, 1817: third avoidance groove, 1818: connecting plug, 1819: second insertion groove, 182: support foot assembly, 1821: main support foot, 1822: auxiliary support foot, 1823: caster, 190: second locking mechanism, 191: spring pin assembly, 1911: spring pin, 1912: third reset member, 192: locking hole, 193: rotation member, 1931: limiting groove, 1932: convex portion, 1933: engaging portion, 194: abutting ring, 1941: recessed region, 1942: abutting region, 195: limiting sleeve, 1951: limiting portion, 200: mounting member, 210: connecting portion, 201: groove.

### DETAILED DESCRIPTION OF THE EMBODIMENTS

In order to make the foregoing objects, features and advantages of the present application more apparent and understandable, a detailed description of the specific embodiments of the present application is set forth below with reference to the accompanying drawings. Many specific details are set forth in the following description to facilitate a full understanding of the present application. However, the present application can be implemented in many other ways different from those described herein, and those skilled in the art can make similar improvements without violating the concept of the present application, and therefore the present application is not limited by the specific embodiments disclosed below.

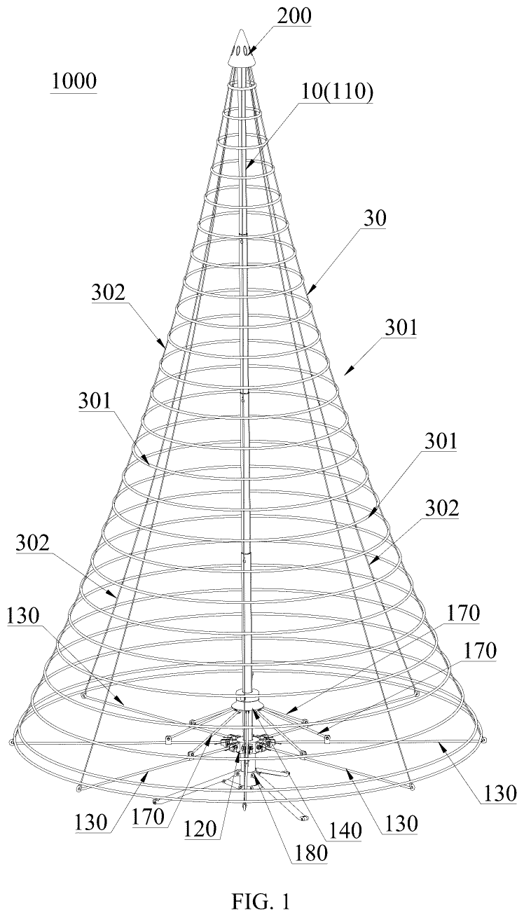

FIG. 1 is a perspective view of a decorative tree 1000 according to an embodiment of the present application. The decorative tree 1000 may include a decoration 30 and a tree stand 10. The decorative tree 1000 is described as below, as well as the decoration 30 and the tree stand 10.

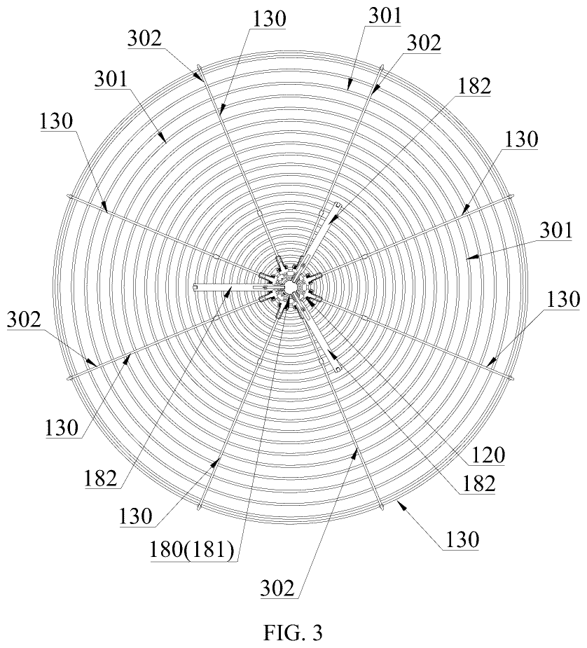

Referring to FIGS. 1 to 4, in an embodiment, the decorative tree 1000 is illustrated, for example, as an example of a decorative lighted tree. The decoration 30 is, for example, a light mesh, which is woven from a plurality of light strings 301 and a plurality of cords 302. Specifically, when expanded, the light mesh has a substantially conical structure. In other words, a space enclosed by the light mesh gradually decreases in diameter from bottom to top. In other embodiments, when expanded, the light mesh may also have other structures, such as a cubic structure or a cylindrical structure. In this embodiment, as shown in FIG. 1, the light mesh with a conical structure when expanded is illustrated. Specifically, each of the light strings 301 is substantially circular with a diameter decreasing from the bottom to the top, and the circular light strings 301 with gradually decreasing diameters are connected one by one by means of the cords 302. Moreover, the plurality of cords 302 may be spaced apart in a circumferential direction of the light strings 301. Alternatively, in other embodiments, each of the cords 302 is substantially circular with a diameter decreasing from the bottom to the top, and the circular cords 302 with gradually decreasing diameters are connected one by one by means of the light strings 301. Moreover, the plurality of light strings 301 may be spaced apart in a circumferential direction of the cords 302.

Referring to FIGS. 1 to 4, an embodiment of present application provides a tree stand 10, which includes: a pole assembly 110, a support mechanism 120, a support arm 130, a movable base 140 and a first locking mechanism 150.

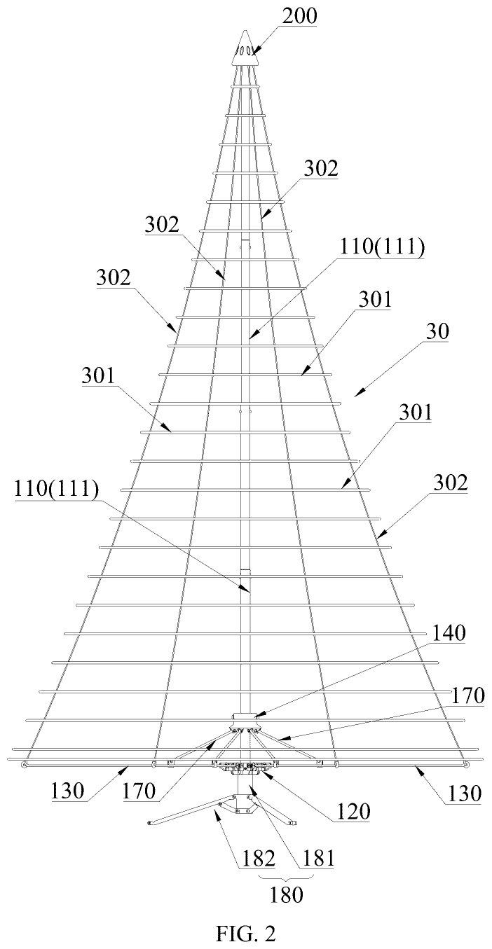

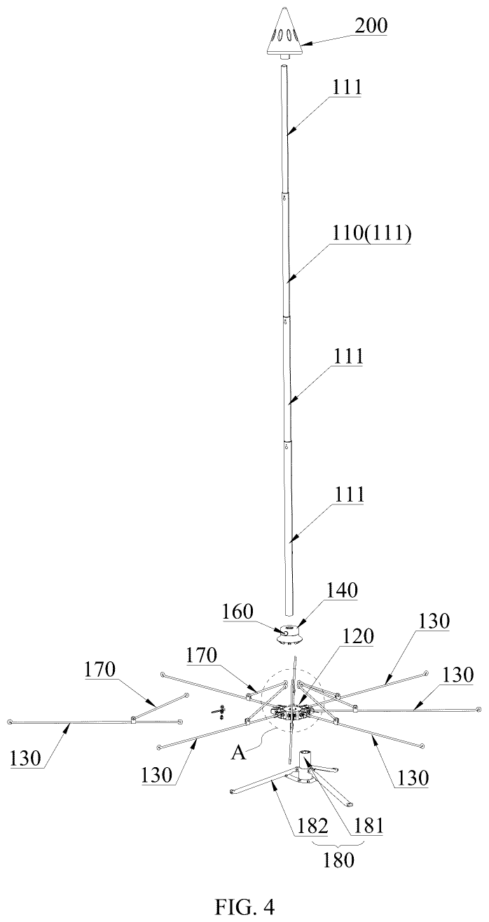

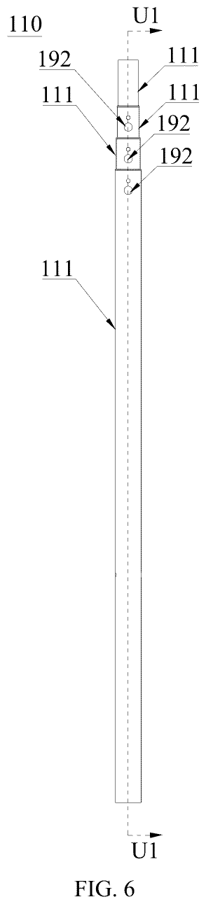

Specifically, as shown in FIGS. 1 and 2, the pole assembly 110 is configured to support the decoration 30, i.e., the light mesh in this embodiment can be extended or expanded in an axial direction of the pole assembly 110 (i.e., a vertical direction). Specifically, in this embodiment, as shown in FIGS. 4 and 6, the pole assembly 110 is a telescopic pole structure, i.e., the pole assembly 110 is telescopic to change a length of the pole assembly 110. In other embodiments, the pole assembly 110 may be a fixed pole structure, i.e., the length of the pole assembly 110 is unchangeable.

The following is a specific description of the pole assembly 110 as an example of the telescopic pole structure. As shown in FIGS. 4 and 6, the pole assembly 110 includes at least two slip tubes 111 which have sequentially varying (i.e., sequentially increasing or sequentially decreasing) diameters and are sleeved together. More specifically, in this embodiment, four slip tubes 111 are provided. In another embodiment, two, three, five or more slip tubes 111 may also be provided as required.

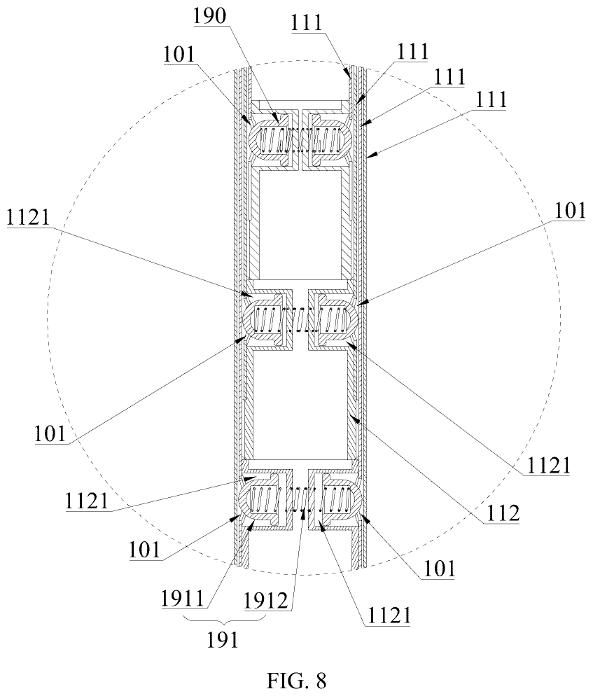

In an embodiment, as shown in FIGS. 6 to 8, a second locking mechanism 190 is disposed between each two of the slip tubes 111 adjacent to each other and sleeved together, in order to allow the two slip tubes 111 adjacent to each other and sleeved together to be fixed relative to each other, and to avoid any two of the slip tubes 111 from being randomly sliding relative to each other, or disengaging from each other. In order to clearly illustrate the specific configuration and the operating principle of the second locking mechanism 190 in this embodiment, two of the slip tubes 111 adjacent to each other and sleeved together are illustrated below as an example. As shown in FIGS. 6 and 8, the second locking mechanism 190 includes a spring pin assembly 191 and a locking hole 192. Among the two slip tubes 111, the locking hole 192 is disposed on an outer slip tube 111, and the spring pin assembly 191 is disposed on an inner slip tube 111. The spring pin assembly 191 can be engaged with the locking hole 192, and thus when the two slip tubes 111 are moved relative to each other so that the spring pin assembly 191 is aligned to the locking hole 192, the spring pin assembly 191 is inserted into the locking hole 192 to lock the two slip tubes adjacent to each other and sleeved together.

Referring to FIGS. 6 and 8, in an embodiment, among the two slip tubes 111 adjacent to each other and sleeved together, the inner slip tube is provided with a telescoping hole 101 configured to receive the spring pin assembly 191. Specifically, the spring pin assembly 191 includes a spring pin 1911 and a third reset member 1912 which abut against each other. The third reset member 1912 biases the spring pin 1911 to extend out of the telescoping hole 101, so that the spring pin 1911 is engaged with the locking hole 192. The third reset member 1912 is, for example, an elastic member such as a spring or an elastic sheet. Specifically, in this embodiment, the third reset member 1912 is a spring. More specifically, an end of the spring pin 1911 is located in the telescoping hole 101, and another end of the spring pin 1911 can extend out of the telescoping hole 101. The third reset member 1912 is disposed in the telescoping hole 101 and abuts against the spring pin 1911. When the pole assembly 110 is in a retracted state, the spring pin 1911 located on the inner slip tube 111 presses against the inner wall of the outer slip tube 111, the spring pin 1911 is fully received in the telescoping hole 101, and the third reset member 1912 is in a compressed state. When the pole assembly 110 extends gradually, the two slip tubes 111 adjacent to each other and sleeved together move away from each other. When the spring pin 1911 moves to the locking hole 192 of the outer slip tube 111 with the inner slip tube 111, the inner wall of the outer slip tube 111 does not presses against the spring pin 1911, i.e., a pressing force applied on the spring pin 1911 is removed. Thus, the third reset member 1912 resets to push the spring pin 1911 to extend through the telescoping hole 101 and the locking hole 192, and finally, the spring pin 1911 is engaged in the locking hole 192. When the pole assembly 110 is required to be switched from the extended state to the retracted state, the spring pin 1911 is pressed so that the spring pin 1911 is withdrawn from the locking hole 192. Thus, the two slip tubes 111 adjacent to each other and sleeved together can be unlocked from each other, allowing the two slip tubes 111 to move relative to each other.

Referring to FIG. 8, in an embodiment, the spring pin assembly 191 includes two spring pins 1911. The two spring pins 1911 are disposed opposite to each other. Specifically, the inner slip tube 111 is provided with two telescoping holes 101, and the outer slip tube 111 is provided with two locking holes. The third reset member 1912 is disposed between the two spring pins 1911 to bias the two spring pins 1911 to move in a direction of extending out of the corresponding telescoping hole 101, respectively, so that the two spring pins 1911 can be respectively engaged with the corresponding locking hole 192. In this way, the stability between the two slip tubes 111 adjacent to each other and sleeved together is improved when they are fixed relative to each other.

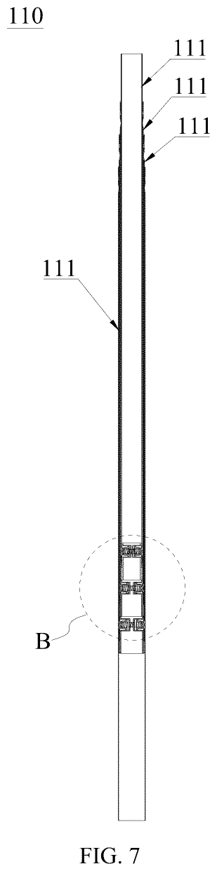

Referring to FIGS. 7 and 8, in an embodiment, among the two slip tubes 111 adjacent to each other and sleeved together, the spring pin assembly 191 is disposed at a bottom end of the inner slip tube 111, and the locking hole 192 is disposed at a top end of the outer slip tube 111, so that it is possible to maximize the range of extension and contraction between the above two slip tubes 111.

Referring to FIG. 8, in an embodiment, a mounting base 112 is disposed in each of the slip tubes 111 provided with the spring pin assembly 191. The mounting base 112 is configured to support the spring pin assembly 191, so as to prevent the spring pin assembly 191 from falling out of the corresponding slip tube 111. Specifically, the mounting base 112 is provided with two mounting grooves 1121, which are disposed opposite to each other. The spring pin 1911 is slidably disposed in the corresponding mounting groove 1121. A groove bottom of each of the two mounting grooves 1121 is provided with a through hole (not shown). Two through holes are in communication with each other. The third reset member 1912 extends through the two through holes and abuts against the two spring pins 19111.

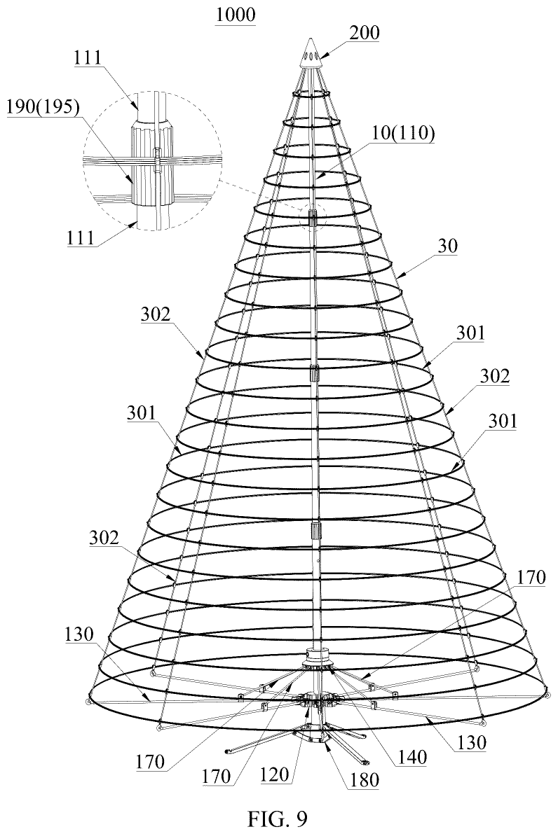

FIG. 9 is a perspective view of a decorative tree according to another embodiment of the present application.

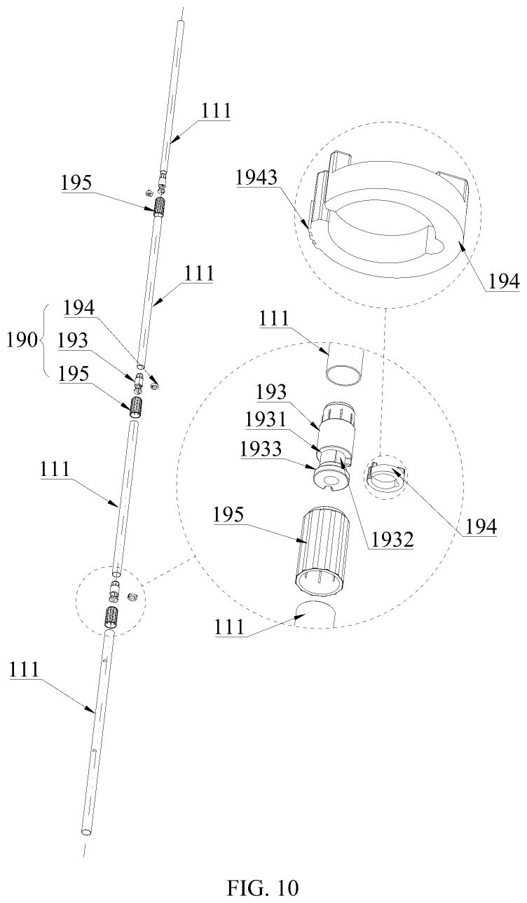

Referring to FIGS. 9 and 10, in another embodiment, the unlocking mechanism 190 includes a rotation member 193 and an abutting ring 194. Similarly, in order to clearly illustrate the operating principle of the second locking mechanism 190 in this embodiment, two of the slip tubes 111 adjacent to each other and sleeved together are illustrated below as an example.

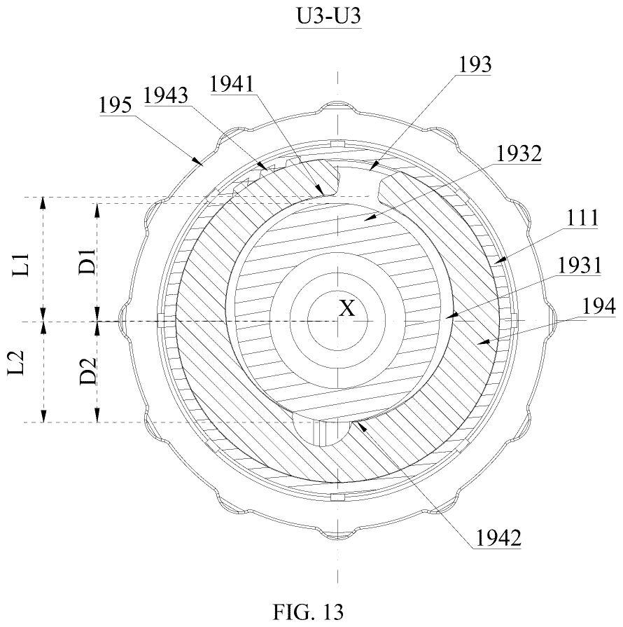

Referring to FIGS. 10, 12 and 13 together, specifically, the rotation member 193 is connected to an end of the inner slip tube 111 and is capable of rotating with the inner slip tube 111 relative to the outer slip tube 111. An axis of rotation of the rotation member 193 relative to the outer slip tube 111 coincides with an axis of rotation of the inner slip tube 111 relative to the outer slip tube 111, and both are the axis of rotation X. A part of the rotation member 193 is received in the inner slip tube 111, and another part of the rotation member 193 extends out of the inner slip tube 111. An outer contour of the rotation member 193 is substantially cylindrical. A maximum diameter of the rotation member 193 is slightly less than an inner diameter of the outer slip tube 111, so that the inner slip tube 111 is capable of driving the rotation member 193 to slide smoothly relative to the outer slip tube 111. A limiting groove 1931 is formed on the rotation member 193. The limiting groove 1931 is disposed in a circumferential direction of the rotation member 193 and is located outside the inner slip tube 111. The groove bottom of the limiting groove 1931 has a convex portion 1932 protruding outward in a circumferential direction. The convex portion 1932 is in a smooth transition with a bottom wall of the limiting groove 1932. In this way, a transverse cross-section of the rotation member 193 at the limiting groove 1931 has a substantially “cam” structure (see FIG. 13). Specifically, a distance DI from the convex portion 1932 to the axis of rotation X is greater than a distance D2 from the bottom wall of the limiting groove 1931 to the axis of rotation X.

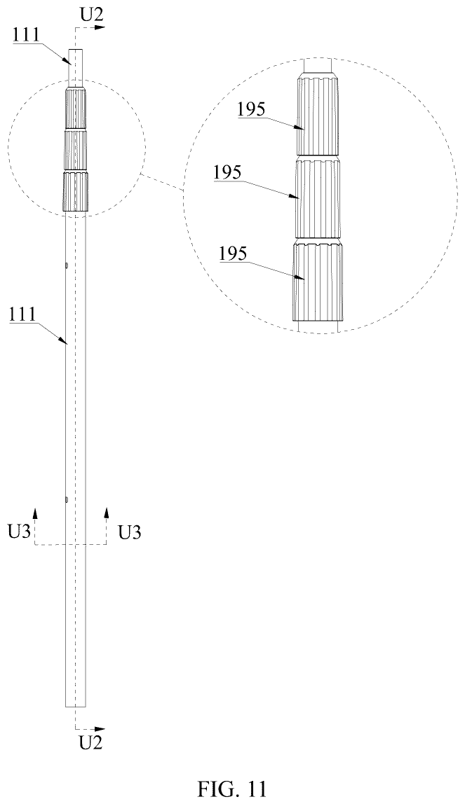

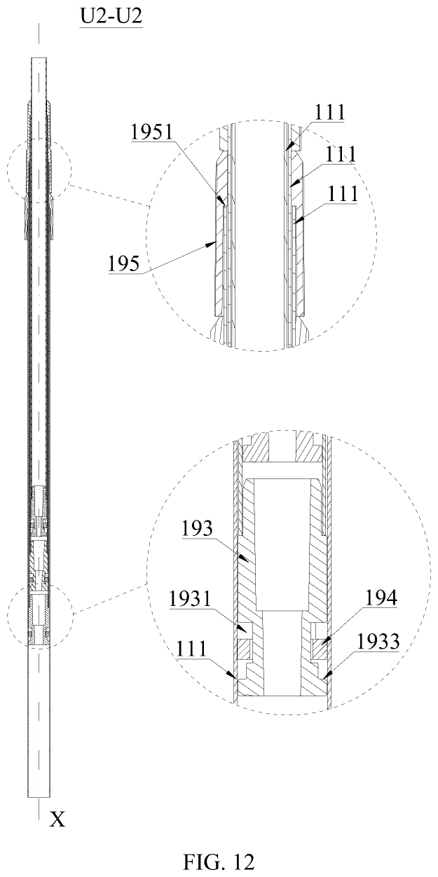

Referring to FIG. 12, the abutting ring 194 is sleeved on the rotation member 193. More specifically, the abutting ring 194 is sleeved at the limiting groove 1931. Referring to FIG. 13, on the sectioning plane, since the inner slip tube 111 of the two adjacent slip tubes 111 is not sectioned, the inner slip tube 111 is invisible in FIG. 13. In the cross-sectional view shown in FIG. 13, a part of the abutting ring 194 is received in the limiting groove 1931, and another part of the abutting ring 194 projects from the limiting groove 1931 and is in contact with the outer slip tube 111. In this way, when the rotation member 193 slides relative to the outer slip tube 111, the abutting ring 194 is driven by a sidewall of the limiting groove 1931, to move with the rotation member 193. When the rotation member 193 rotates with the inner slip tube 111 (i.e., rotates about its own axis) relative to the outer slip tube 111, the abutting ring 194 can be kept stationary (i.e., the abutting ring 194 does not rotate relative to the outer slip tube 111) by friction between the abutting ring 194 and the outer slip tube 111. In conjunction with FIG. 11, in this embodiment, an outer side of the abutting ring 194 (i.e., a side facing the outer slip tube 111) is provided with a convex rib 1943 protruding outward. The convex rib 1943 extends in the axial direction to increase the friction between the abutting ring 194 and the outer slip tube 111, thereby further limiting relative rotation between the abutting ring 194 and the outer slip tube 111.

The rotation member 193 is rotatable between an engaged position and an unengaged position. When the rotation member 193 is in the unengaged position (see FIG. 13), a gap is formed between the convex portion 1932 and a tube wall of the abutting ring 194, i.e., the convex portion 1932 is not in contact with the abutting ring 194. During the rotation of the rotation member 193 towards the engaged position, the rotation member 193 drives the convex portion 1932 to rotate relative to the abutting ring 194. When the rotation member 193 rotates to the engaged position, the convex portion 1932 pushes against the abutting ring 194 to bring the abutting ring 194 to abut against the tube wall of the outer slip tube 111, so that the friction can occur between the abutting ring 194 and the tube wall of the outer slip tube 111. In this way, movement of the abutting ring 194 relative to the outer slip tube 111 in the axial direction of the pole assembly 110 (i.e., an extending direction of the pole assembly 110) is limited by the friction between the abutting ring 194 and the tube wall of the outer slip tube 111, thereby limiting the axial movement of the inner slip tube 111 relative to the outer slip tube 111, and finally realizing the interlocking between the two slip tubes 111 adjacent to each other and sleeved together.

As shown in FIG. 13, an outer contour of a cross-section of the abutting ring 194 is substantially circular. A center of the circular outer contour (i.e., a ring center of the abutting ring 194) is substantially coaxial with the axis of rotation X. An inner ring wall of the abutting ring 194 is substantially in the shape of a “cam”, or in the shape of a circle with a center offsetting from the axis of rotation X. The inner ring wall of the abutting ring 194 is formed with a recessed region 1941 and an abutting region 1942. A distance LI from the ring center of the abutting ring 194 (i.e., the axis of rotation X) to the recessed region 1941 is greater than a distance L2 from the ring center of the abutting ring 194 to the abutting region 1942. The distance L1 from the recessed region 1941 to the axis of rotation X is greater than a distance DI from the convex portion 1932 to the axis of rotation X. The distance L2 from the abutting region 1942 to the axis of rotation X is greater than or equal to a distance D2 from the bottom wall of the limiting groove 1931 to the axis of rotation X. The distance L2 from the abutting region 1942 to the axis of rotation X is less than the distance D1 from the convex portion 1932 to the axis of rotation X. That is, L1>D1>L2>D2. In this way, when the rotation member 193 is in the unengaged position, the convex portion 1932 faces, but is not in contact with the recessed region 1941, the bottom wall of the limiting groove 1931 is not in contact with the abutting region 1942 or is just in contact with the abutting region 1942, and no friction occurs between the rotation member 193 and the inner ring wall of the abutting ring 194. When the rotation member 193 is in the engaged position, the convex portion 1932 pushes against the abutting region 1942 to push the abutting ring 194 toward the tube wall of the outer slip tube 111, so that the friction between the abutting ring 194 and the tube wall of the outer slip tube 111 is increased, thereby limiting the relative rotation between the rotation member 193 and the outer slip tube 111. In this embodiment, when the two slip tubes 111 do not need to be locked, i.e., when the two slip tubes 111 adjacent to each other and sleeved together are retractable relative to each other, the rotation member 193 is in the unengaged position, i.e., the convex portion 1932 faces the recessed region 1941 (see FIG. 13). When the two slip tubes 111 need to be locked, i.e., when the two slip tubes 111 adjacent to each other and sleeved together are fixed relative to each other, the inner slip tube 111 is rotated and drives the rotation member 193 to rotate to the engaged position, and the convex portion 1932 faces and abuts against the abutting region 1942, so that the abutting ring 194 abuts against the tube wall of the outer slip tube 111. That is, when the two slip tubes 111 need to be switched to a locked state, the user only needs to rotate the inner slip tube 111, so that the convex portion 1932 on the rotation member 193 is then rotated until it abuts against the abutting ring 194 to push the abutting ring 194 against the outer slip tube 111. Referring to FIGS. 11 and 12, in an embodiment, the second locking mechanism 190 further includes a limiting sleeve 195. Among the two slip tubes 111 adjacent to each other and sleeved together, the limiting sleeve 195 is sleeved on an end of the outer slip tube 111. In this embodiment, the limiting sleeve 195 is fixed at the end of the outer slip tube 111 by interference fit, bonding, riveting, bolting or the like. In some alternative embodiments, the limiting sleeve 195 may also be slidably disposed on the end of the outer slip tube 111, and the limiting sleeve 195 has a small sliding stroke relative to the slip tubes 111, so that at least a part of the limiting sleeve 195 extends beyond the end of the outer slip tube 111 in the extending direction of the pole assembly 110, to allow the limiting sleeve 195 to limit the inner slip tube 111. The inner slip tube 111 can slide relative to the limiting sleeve 195 and the outer slip tube 111. The limiting sleeve 195 includes a limiting portion 1951. Referring to FIG. 13, an end of the rotation member 193 away from the inner slip tube 111 has an engaging portion 1933. The engaging portion 1933 is stopped by the limiting portion 1951 to prevent the inner slip tube 111 from being disengaged from the outer slip tube 111. In this way, the two slip tubes 111 can be prevented from being disengaged from each other when they are extended in the axial direction subjected to a pulling force.

Still referring to FIGS. 1 and 4, in this embodiment, the support mechanism 120 is fixed on the pole assembly 110. The support arm 130 is in hinged connection with the support mechanism 120, and has an unfolded state (see FIGS. 1 and 4) and a folded state (see FIGS. 9 and 12), and the support arm 130 is configured to support the decoration 30. Specifically, the top of the light mesh is connected to the top end of the pole assembly 110, and the bottom of the light mesh is connected to the support arm 130. In an embodiment, a plurality of support arms 130 are provided. The plurality of support arms 130 are disposed on the support mechanism 120 at an equal spacing in the circumferential direction of the support mechanism 120. An end of each of the support arms 120 away from the support mechanism 120 is connected to the bottom of the light mesh. In this way, the light mesh can be evenly spread when each of the support arms 130 is in the unfolded state, so that the light mesh is unfolded to have a shape of a cone or a bell, thereby playing a good decorative effect. For example, in this embodiment, eight support arms 130 are provided.

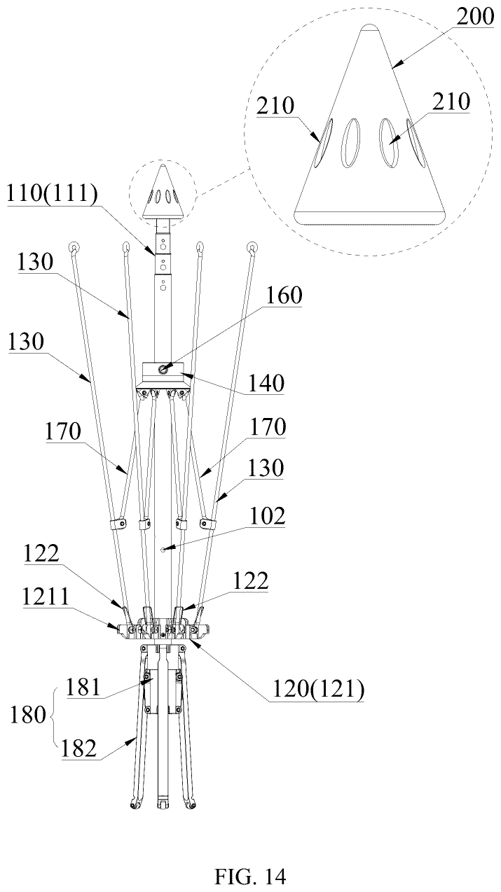

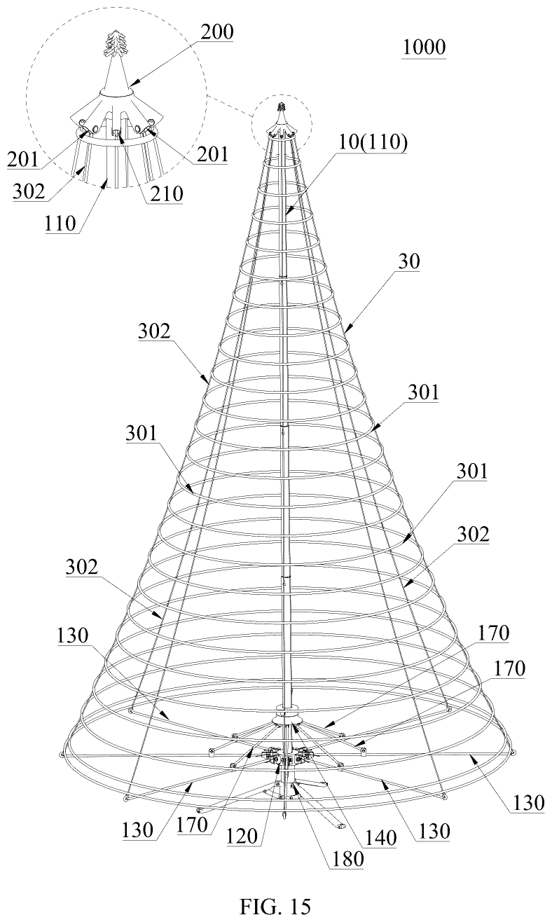

Specifically, in an embodiment, the tree stand 10 further includes a mounting member 200. The mounting member 200 is detachably connected to the pole assembly 110. Specifically, the mounting member 200 is connected to the innermost slip tube 111 of the four slip tubes 111 that are sequentially sleeved together, and is located at the top end of the slide tube 111. The mounting member 200 is provided with a connecting portion 210 (see FIG. 14 or FIG. 15). The connecting portion 210 is configured to be connected to the decorations 30, specifically, to be connected to the corresponding cord 302.

Specifically, in this embodiment, as shown in FIGS. 1 and 14, the connecting portion 210 is a perforation extending through the mounting member 200. After an end of the corresponding cord 302 extends through the perforation, a knot (not shown) is formed by knotting. The knot abuts against an opening edge of the perforation to realize a connection between the cord 302 and the mounting member 200. It should be noted that a size of the knot is greater than a size of the perforation, so as to enable the knot to abut against the opening edge of the perforation. In another alternative embodiment, after extending through the perforation, the end of the cord 302 may be connected to another limiting member (such as a rod or the like), and this limiting member can abut against the edge of the perforation like the above knot.

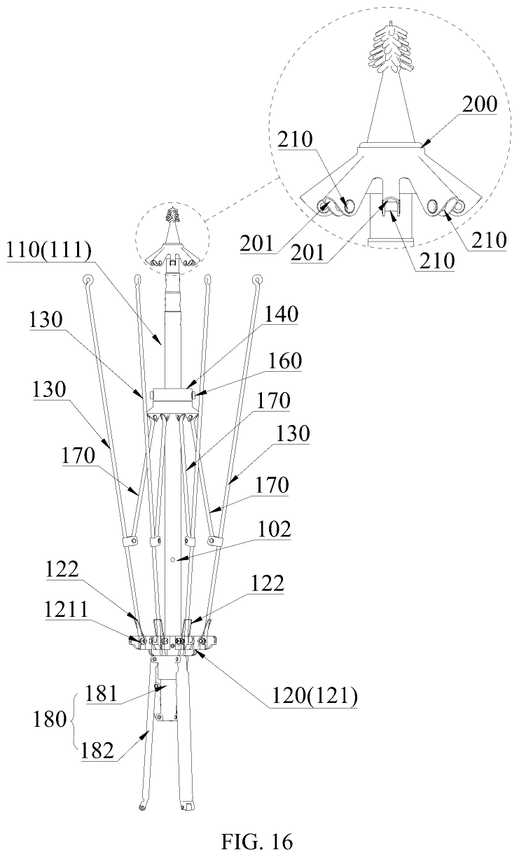

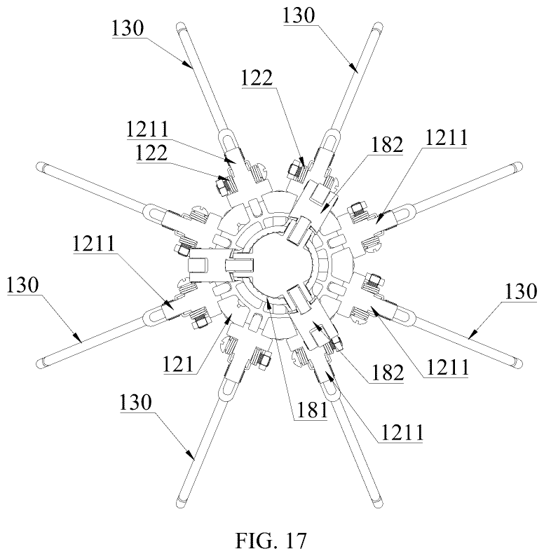

Optionally, in other embodiments, as shown in FIGS. 15 and 16, the connecting portion 210 is a connecting rod disposed on the mounting member 200. Specifically, a groove 201 is formed on the mounting member 200. The connecting rod is installed in the groove 201. Further, the end of the cord 302 is provided with a connecting hook. The connecting hook is configured to hook the connecting rod to realize the connection between the cord 302 and the mounting member 200.

Referring to FIGS. 1 and 14, in an embodiment, the movable base 140 is movably disposed on the pole assembly 110 and operably connected to the support arms 130, so as to enable the support arms 130 to be switched between the unfolded state and the folded state. In this way, the states of the support arms 130 can be controlled by manipulating the movable base 140.

It should be noted that the wording “the movable base 140 being movably disposed on the pole assembly 110” means that the movable base 140 is movable in an axial direction or a length direction of the pole assembly 110 (i.e., the extending direction of the pole assembly 110).

Referring to FIGS. 14, 18 and 19, in an embodiment, the first locking mechanism 150 is disposed on the movable base 140 and has a locked state and an unlocked state. Specifically, when the first locking mechanism 150 is in the locked state, it is capable of locking the support arms 130 in the unfolded state. When the first locking mechanism 150 is in the unlocked state, it is capable of unlocking the support arms 130 from the unfolded state.

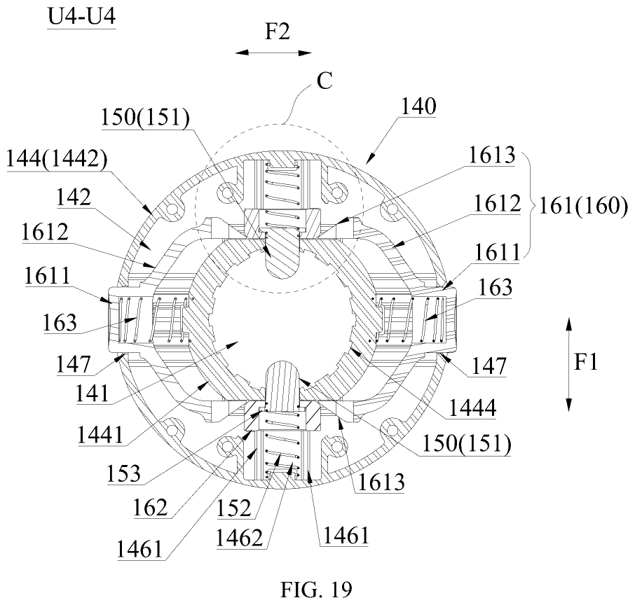

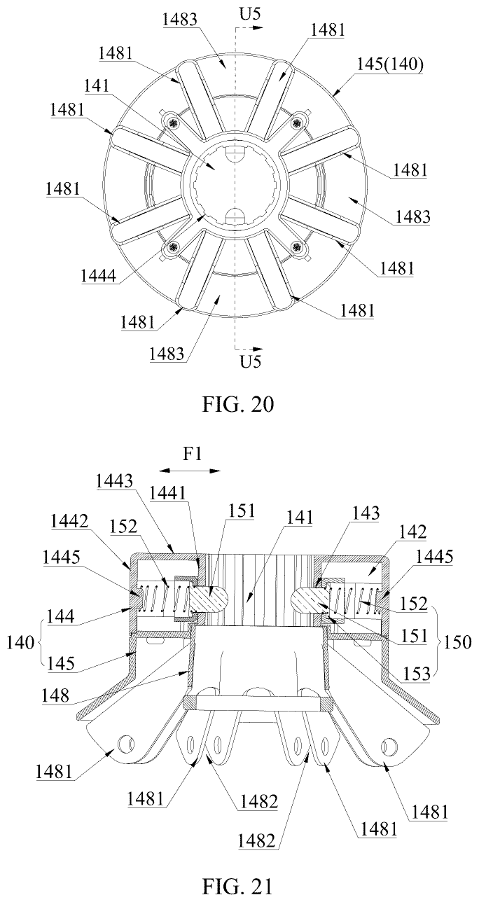

In an embodiment, the pole assembly 110 (see FIGS. 14 and 16) is provided with a locking recess 102. The locking recess 102 is a hole or a slot. Specifically, the locking recess 102 is a hole and is disposed on an outermost slip tube of the four slip tubes 111 that are sequentially sleeved together. As shown in FIGS. 19 to 21, the first locking mechanism 150 includes a locking member 151. The locking member 151 is provided on the movable base 140 and is movable in a first direction F1, so that the locking member 151 has a locked position and an unlocked position. More specifically, when the support arms 130 are in the unfolded state and the locking member 151 is in the locked position, the locking member 151 extends into the locking recess 102 so that the first locking mechanism 150 is in the locked state. When the locking member 151 is in the unlocked position, the locking member 151 is withdrawn s from the locking recess 102 so that the first locking mechanism 150 is in the unlocked state. The first direction F1 is parallel to the radial direction of the pole assembly 110.

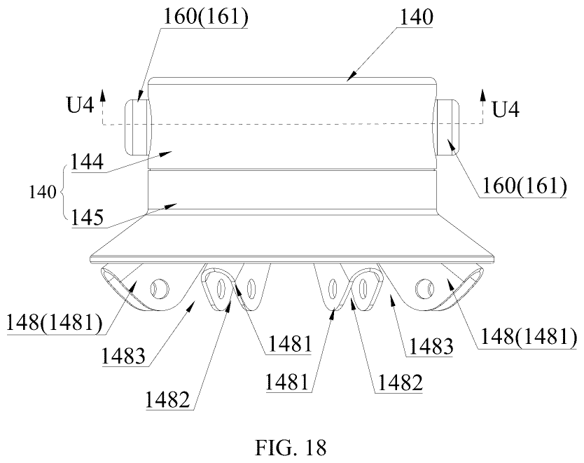

Referring to FIGS. 18 to 20, in an embodiment, the movable base 140 has a through channel 141. The movable base 140 is sleeved outside of the pole assembly 110 by the through channel 141, i.e., by inserting the pole assembly 110 into the through channel 141 (see FIG. 14). The movable base 140 further includes a receiving cavity 142 and a through hole 143. The through hole 143 is in communication with the receiving cavity 142 and the through channel 141. The locking member 151 is at least partially movably disposed in the receiving cavity 142. In other embodiments, the movable base 140 does not need to be provided with the receiving cavity 142 and the through hole 143, and the locking member 151 may be movably disposed on an upper end surface or a lower end surface of the movable base 140 directly.

Specifically, as shown in FIGS. 19 and 21, the first locking mechanism 150 further includes a first reset member 152. The first reset member 152 abuts against the locking member 151 to bias the locking member 151 to move from the unlocked position to the locked position. The first reset member 152 is an elastic member, for example, a spring, an elastic sheet or the like. Specifically, the first reset member 152 is a spring provided in the receiving cavity 142. The first reset member 152 is configured to be located between and respectively abut against an inner wall of the receiving cavity 142 and the locking member 151 to bias the locking member 151 to move in a direction of extending out of the through hole 143.

Specifically, as shown in FIGS. 18, 21 and 22, the movable base 140 includes an upper shell 144 and a lower shell 145 which are connected to each other. The upper shell 144 and the lower shell 145 is detachably connected, for example, threadedly connected by a connector such as a screw, or fastened to each other by a connector such as an engaging member. The through channel 141 includes a first channel 1411 and a second channel 1412. The upper shell 144 includes an inner ring portion 1441 provided with the first channel 1411 and an outer peripheral portion 1442 surrounded the inner ring portion 1441. The outer peripheral portion 1442 is connected to the inner ring portion 1441. The receiving cavity 142 is formed between the outer peripheral portion 1442 and the inner ring portion 1441. The inner ring portion 1951 is provided with the through hole 143. In this embodiment, the inner ring portion 1441 may be regarded as an annular inner ring baffle, and the outer peripheral portion 1442 may be regarded as an annular outer ring baffle, and the inner ring portion 1441 and the outer peripheral portion 1442 are connected by a plate 1443. The annular inner ring baffle, the plate 1443 and the annular outer ring baffle together define the receiving cavity 142 with an opening at an end. The upper shell 144 may be sleeved outside the pole assembly 110 by means of the first channel 1411. Further, the lower shell 145 has the second channel 1412. The lower shell 145 is sleeved outside the pole assembly 110 by means of the second channel 1412.

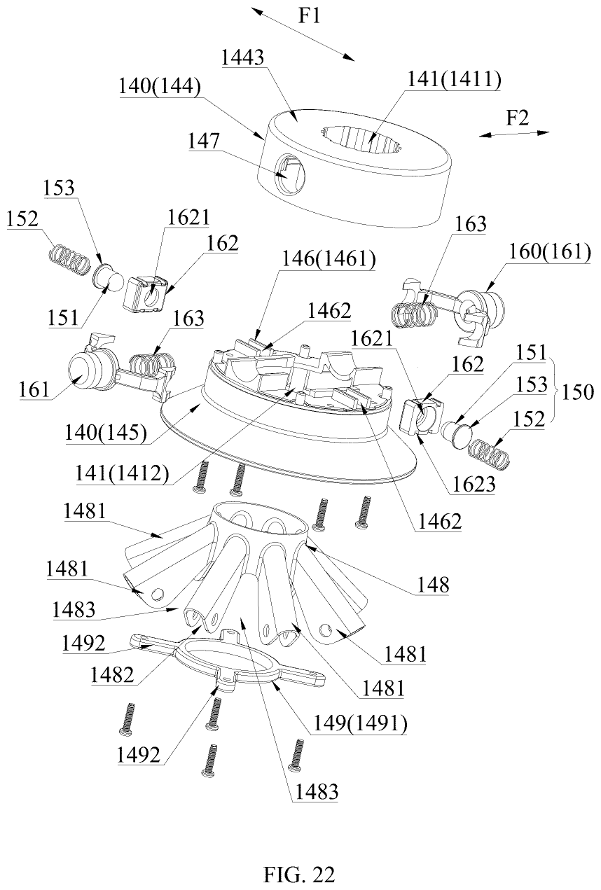

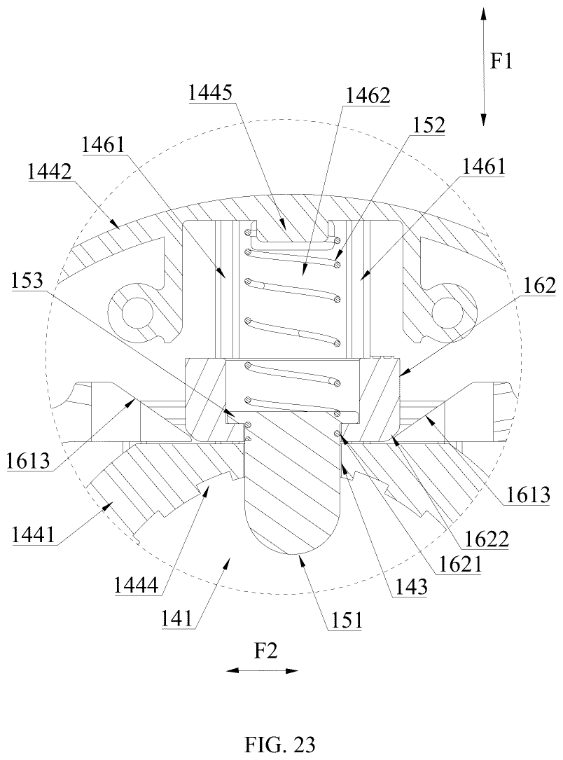

In an embodiment, a side of the inner ring portion 1441 facing the first channel 1411 is provided with a first avoidance groove 1444 (see FIGS. 22 and 23). The first avoidance groove 1444 extends in a length direction of the first channel 1411. Specifically, the side of the inner ring portion 1441 facing the first channel 1411 is provided with a plurality of first avoidance grooves 1444. The plurality of first avoidance grooves 1444 are spaced apart in a circumferential direction of the first channel 1411. In this way, the contact area between the movable base 140 and the pole assembly 110 can be reduced, and when the pole assembly 110 is partially deformed, for example, when a bump is formed on the pole assembly 110, the first avoidance grooves 1444 can pass over the bump, so that the movement of the movable base 140 will not be affected.

Referring to FIGS. 22 and 23, in an embodiment, a side of the lower shell 145 facing the upper shell 144 is provided with a limiting element 146. Specifically, the limiting element 146 includes two limiting guides 1461 facing each other. A limiting slot 1462 is formed between the two limiting guides 1461. The limiting slot 1462 extends in the first direction F1, and the first reset member 152 and locking member 151 are movably disposed and limited in the limiting slot 1462. Movement paths of the first reset member 152 and the locking member 151 are ensured by the first limiting slot 1462. In addition, a side of the outer peripheral portion 1442 facing the receiving cavity 142 is provided with a limiting post 1445. The limiting post 1445 faces the through hole 143. The first reset member 152 is sleeved on the limiting post 1445, which can further prevent the first reset member 152 from being deflected.

Referring to FIGS. 14, 18 and 19, in an embodiment, the tree stand 10 further includes an unlocking mechanism 160. The unlocking mechanism 160 is configured to drive the locking member 151 to move from the locked position to the unlocked position, in other words, the unlocking mechanism 160 is configured to drive the first locking mechanism 150 to switch from the locked state to the unlocked state.

Specifically, as shown in FIGS. 19 and 22, the unlocking mechanism 160 includes an unlocking member 161. The unlocking member 161 is operably connected to the locking member 151 to drive the locking member 151 to move from the locked position to the unlocked position. Specifically, the unlocking member 161 has a first position and a second position. The locking member 151 is in the locked position when the unlocking member 161 is in the first position. The locking member 151 is in the unlocked position when the unlocking member 161 is in the second position.

Still referring to FIGS. 19 and 22, in an embodiment, the unlocking member 161 is disposed on the movable base 140 and is movable in the second direction F2, to enable the unlocking member 161 to switch between the first position and the second position. When moving from the first position to the second position, the unlocking member 161 drives the locking member 151 to move from the locked position to the unlocked position in the first direction F1. The second direction is parallel to the radial direction of the pole assembly 110 and not parallel to the first direction F1. Specifically, the second direction F2 is substantially perpendicular to the first direction F1.

Still referring to FIGS. 19, 22 and 23, the unlocking mechanism 160 further includes a guide member 162. The guide member 162 is disposed in the receiving cavity 142 and provided with a limiting hole 1621 corresponding to the through hole 143. The locking member 151 is movably inserted into the limiting hole 1621 and at least partially limited in the limiting hole 1621. Referring to FIG. 23, the locking member 151 is provided with a limiting boss 153. The locking member 151 extends through the limiting hole 1621. The limiting boss 153 is capable of abutting against the opening edge of the limiting hole 1621 to limit at least a part of the locking member 151 in the limiting hole 1621, thereby preventing the whole locking member 151 from being separated from the limiting hole 1621 and the through hole 143 when the end of the locking member 151 away from the first reset member 152 extends out of the limiting hole 1621 and the through hole 143.

Further, as shown in FIGS. 19 and 22, the outer peripheral portion 1442 is provided with an operation hole 147 in communication with the receiving cavity 142. The unlocking member 161 extends through the operation hole 147 and is movably disposed in the receiving cavity 142. When the unlocking member 161 moves from the first position to the second position in the second direction F2, the unlocking member 161 pushes against the guide member 162 to move in the first direction F1 and drives the locking member 151 to move from the locked position to the unlocked position.

In order to avoid deflection of the guide member 162 during movement, referring to FIG. 22, in an embodiment, one of the lower shell 145 and the guide member 162 is provided with a limiting guide 1461, and another of the lower shell 145 and the guide member 162 is provided with a sliding guide groove 1451. The limiting guide 1461 and the sliding guide groove 1623 extend in the first direction F1 and are in sliding engagement with each other. Specifically, in this embodiment, the limiting guide 1461 is located on a side of the lower shell 145 facing the upper shell 144, and the sliding guide groove 1623 is formed on the guide member 162.

In this embodiment, as shown in FIGS. 19 and 22, the unlocking member 161 includes an operation button 1611 and a push arm 1612 which are connected. The push arm 1612 is movably disposed in the receiving cavity 142, and the operation button 1611 extends through the operation hole 147 and is connected to the push arm 1612. When the operation button 1611 is moved in the second direction F2, the push arm 1612 is driven to move in the second direction F2 and to abut against the guide member 162.

In an embodiment, as shown in FIGS. 19 and 23, an end of the push arm 1612 away from the operation button 1611 has a driving bevel 1613. The driving bevel 1613 is inclined relative to the second direction F2, so as to ensure that the unlocking member 161 (which may be regarded as the push arm 1612) is capable of pushing the locking member 151 to move in the first direction F1 when moving from the first position to the second position in the second direction F2. Optionally, when the unlocking member 161 is in the first position and the locking member 151 is in the locked position, the guide member 162 abuts against a bottom of the driving bevel 1613. In other embodiments, the guide member 162 may be not in contact with the driving bevel 1613 when the unlocking member 161 is in the first position and the locking member 151 is in the locked position. Referring to FIG. 23, the guide member 162 includes a guide portion 1622. The guide portion 1622 is curved and configured to abut against the drive bevel 1613 to be allowed to slide along the driving bevel 1613. In other words, when the push arm 1612 is moved from the first position to the second position, the driving bevel 1613 can abuts against a side of the guide member 162 facing the through channel 141 by the guide portion 1622.

Returning to refer to FIGS. 19 and 22, in an embodiment, the unlocking mechanism 160 further includes a second reset member 163. The second reset member 163 is located between and respectively abuts against the operation button 1611 and the inner ring portion 1441 to bias the unlocking member 161 to move from the second position to the first position.

Specifically, in this embodiment, as shown in FIGS. 19 and 22, two first locking mechanisms 150 and two guide members 162 are provided. The inner ring portion 1441 is provided with two through holes 143. Two locking members 151 are disposed corresponding to the two guide members 162. Each locking member 151 is capable of extending out of the corresponding through hole 143. More specifically, the unlocking member 161 includes two push arms 1612. The two push arms 1612 are movably disposed in the receiving cavity 142 and are connected to the operation button 1611. More specifically, in a circumferential direction of the inner ring portion 1441, the unlocking member 161 is located between the two first locking mechanisms 150, i.e., one of the push arms 1612 is connected to corresponding one of the guide members 162 and another of the push arms 1612 is connected to the another of the guide members 162. In this way, when the operation button 1611 is moved in the second direction F2, the two push arms 1612 are simultaneously driven to move in the second direction F2 and to respectively abut against the guide member 162. As such, the two locking members 151 can be controlled at the same time. In other embodiments, the unlocking member 161 may include one operation button 1611 and one push arm 1612. The number of the unlocking member 161 is set corresponding to the number of the locking member 151, and one unlocking member 161 acts on one locking member 151.

Still referring to FIGS. 19 and 22, in this embodiment, two unlocking mechanisms 160 are provided. The two unlocking mechanisms 160 and the two first locking mechanisms 150 are disposed alternately in the movable base 140 in the circumferential direction of the inner ring portion 1441. Specifically, the two unlocking mechanisms 160 face each other, and the two first locking mechanisms 150 face each other. In this way, during unlocking, each locking member 151 can be simultaneously pushed by the driving bevels 1613 on the push arms 1612 on its left and right sides.

The movable base 140 is movably disposed on the pole assembly 110 and operably connected to the support arms 130, to enable the support arms 130 to be switched between the unfolded state (refer to FIG. 1) and the folded state (refer to FIG. 14). As shown in FIGS. 1 and 14, in this embodiment, the tree stand further includes a link member 170. The movable base 140 is operably connected to the support arm 130 through the link member 170. Specifically, as shown in FIGS. 18 and 22, the movable base 140 has a connecting body 148. The connecting body 148 includes a first hinged portion 1481. An end of the link member 170 is hinged to the first hinged portion 1481, and another end of the link member 170 is hinged to the support arm 130 to drive the support arm 130 to switch between the unfolded state and the folded state. Specifically, the first hinged portion 1481 is formed by bending a connecting plate and has a first insertion groove 1482, and an end of the link member 170 is inserted into the first insertion groove 1482 and connected to the connecting plate.

Referring to FIGS. 1, 14, and 18, in this embodiment, the support mechanism 120 is fixedly sleeved outside the pole assembly 110. The plurality of support arms 130 are disposed on the support mechanism 120 at equal spacing in the circumferential direction of the support mechanism 120. Accordingly, a plurality of link members 170 are provided, and the number of the link members 170 is equal to the number of the support arms 130. More specifically, the connecting body 148 is provided with a plurality of the first hinged portions 1481 provided at equal spacing in the circumferential direction of the pole assembly 110, and the number of the first hinged portions 1481 is equal to the number of the link members 210. Ends of each of the link members 170 are hinged to the corresponding support arm 130 and the corresponding first hinged portion 1481 respectively.

Optionally, the connecting body 148 is fixedly connected to a side of the lower shell 145 of the movable base 140 facing away from the upper shell 144; or the connecting body 148 is integrally formed onto the side of the lower shell 145 facing away from the upper shell 144; or the connecting body 148 is detachably connected to the side of the lower shell 145 facing away from the upper shell 144. Specifically, in this embodiment, the connecting body 148 is detachably connected to the side of the lower shell 145 facing away from the upper shell 144 by a screw, or a bolt, or the like. More specifically, referring to FIG. 22, the resisting member 149 is further included in the tree stand 10 in the embodiment. The connecting body 148 is fixed to the lower shell 145 through the resisting member 149 and a screw. The connecting body 148 is a cylindrical structure, and the plurality of the first hinged portions 1481 are disposed on the outer peripheral wall of the connecting body 148 at equal spacing in the circumferential direction of the connecting body 148, i.e., a mounting gap 1483 is formed between the two adjacent first hinged portions 1481 (see FIG. 22). The resisting member 149 includes a circular sleeve 1491 and a connecting pin 1492. The connecting pin 1492 is provided with a connecting hole (not shown). Specifically, a plurality of connecting pins 1492 are provided. The plurality of the connecting pins 1492 are disposed on an outer wall of the circular sleeve 1491 at equal spacing. The number of the first hinged portions 1481 is an integer multiple of (e.g., equal to, double, triple, or triple, etc.) the number of the connecting pins 1492. More specifically, eight first hinged portions 1481 are provided, and four connecting pins 1492 are provided. The four connecting pins 1492 are disposed on the outer wall of the circular sleeve 1491 at equal spacing. During connection, the connecting body 148 abuts against the lower shell 145 by the circular sleeve 1491, and each of the connecting pins 1492 is engaged into the corresponding mounting gap 1483, and then, the screws extend through the connecting holes respectively, to be connected to the lower shell 145 to complete the connection.

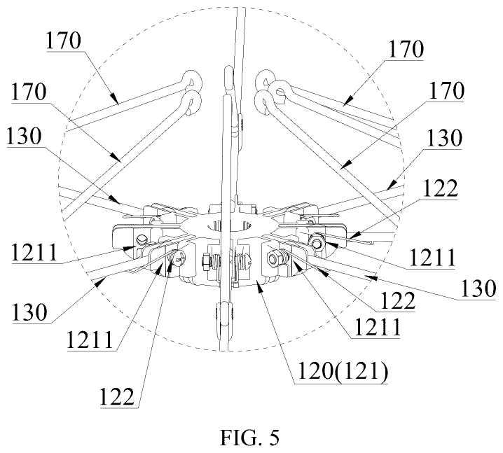

Specifically, referring to FIGS. 4 and 5, the support mechanism 120 includes support bases 121 and torsional springs 122. Each support base 121 is provided with the second hinged portion 1211. More specifically, the number of the torsional springs 122 and the number of the second hinged portions 1211 is set corresponding to the number of the support arms 130. Configurations of one of the second hinged portions 1211 and a corresponding torsional spring 122 are specifically described below as an example. The support arm 130 is hinged to the second hinged portion 1211, the torsional spring is located between and respectively abuts against the support arm 130 and the second hinged portion 1211 to bias the support arm 130 to switch from the unfolded state to the folded state. In this way, when the first locking mechanism 150 is in the unlocked state, under an action of the torsional spring 122, the support arm 130 can be automatically switched from the unfolded state to the folded state, thereby reducing labor strength when the user folds the tree stand 10. In other embodiment, the torsional spring 122 is omitted. When the first the unlocking mechanism 160 is in the unlocked state, the movable base 140 may be manually pulled, and the support arm 130 can be switched to the folded state under an action of the link member 170.

A process of folding the tree stand 10 or the decorative tree 1000 is illustrated below in conjunction with the drawings.

Referring to FIGS. 14 and 19, when the tree stand 10 is folded, the pole assembly 110 is in the retracted state, and an overall height of the tree stand 10 is small, i.e., a longitudinal occupation space is small. Meanwhile, when the first locking mechanism 150 is in the unlocked state, the support arms 130 are in the folded state, and an overall width of the tree stand 10 is small, i.e., a lateral occupation space is small. Therefore, a large space for transportation or storage can be saved when transporting or storing the tree stand 10, facilitating transportation and storage.

Referring to FIGS. 1 and 14, when the tree stand 10 is required to be used to achieve a decorative role, an example in which the pole assembly 110 is placed vertically is described below. Firstly, the movable base 140 is pushed to move downward in the length direction of the pole assembly 110, and drives the link members 170 to move during moving. Since the ends of each of the link members 170 are hinged to the corresponding support arm 130 and the connecting body 148 of the movable base 140 respectively, each of the link members 170 can push the corresponding support arm 130 to be unfold gradually (see FIG. 1). Referring to FIGS. 14 and 19, when the movable base 140 moves to the locking recess 102, the pole assembly 110 does not abut against the locking member 151, and under the action of the first reset member 152, the locking member 151 extends out of the through hole 143 and into the locking recess 102, so that the support arm 130 are kept in the unfolded position. Subsequently, each of the slip tubes 111 of the pole assembly 110 is pulled up one by one, so that the two slip tubes 111 adjacent to each other and sleeved together are moved away from each other until the spring pins 1911 are engaged into the locking holes 192 respectively. During unfolding the support arms 130 and extending the slip tubes 111, the light mesh is driven to expand, thereby finally causing the decorative tree 1000 to be in the unfolded state, to play a good decorative role. In other embodiments, the user may also unfold the support arms 130 and extend the slip tubes 111, and then attach the light mesh on the tree stand 10.

When the decorative tree 1000 needs to be stored or transferred, an example in which the pole assembly 110 is placed vertically is described below. Referring to FIGS. 14, 19 and 23, the user can press the operation button 1611, the operation button 1611 pushes the push arm 1612 to move, and the driving bevels 1613 cooperates with the guiding portion 1622, so that the locking member 151 is withdrawn from the first locking recess 102 and retracts into the through hole 143. The locking member 151 is disengaged from the pole assembly 110, and under the action of each torsional spring 122, the corresponding support arm 130 is allowed to switch automatically from the unfolded state to the folded state, so as to reduce the volume of the tree stand 10. During the folding process, the support arms 130 push the link members 170 to rotate and move, thereby pushing the movable base 140 to move upward in the length direction of the pole assembly 110. When the pole assembly 10 is to be retracted, the spring pins 1911 are pressed to be respectively withdrawn from the locking holes 192 and respectively retract into the telescoping holes 101, so that the two slip tubes 111 which are adjacent to each other and sleeved together are disengaged from each other, allowing the two slip tubes 111 to slide relative to each other to shorten the overall length of the pole assembly 10. The light mesh is driven to be folded during folding the support arms 130 and shortening the slip tubes 111, so that the decorative tree 1000 is in the folded state. In other embodiments, the user can also remove the light mesh from the tree stand 10, and then perform the above folding operation on the tree stand 10.

Referring to FIGS. 1 and 2, in an embodiment, the tree stand 10 further includes a bottom support mechanism 180. The bottom support mechanism 180 includes a mounting assembly 181 and a support foot assembly 182. The mounting assembly 181 is configured to be connected to the pole assembly 110. The support foot assembly 182 is hinged to the mounting assembly 181 and has an extended state (see FIG. 2) and a collapsed state (see FIG. 14). When the support foot assembly 182 is in the extended state, the pole assembly 110 can be stably supported, avoiding situations such as falling over. When the support foot assembly 182 is in the collapsed state, the overall volume of the tree stand 10 can be further reduced, reducing the space occupied by the tree stand 10.

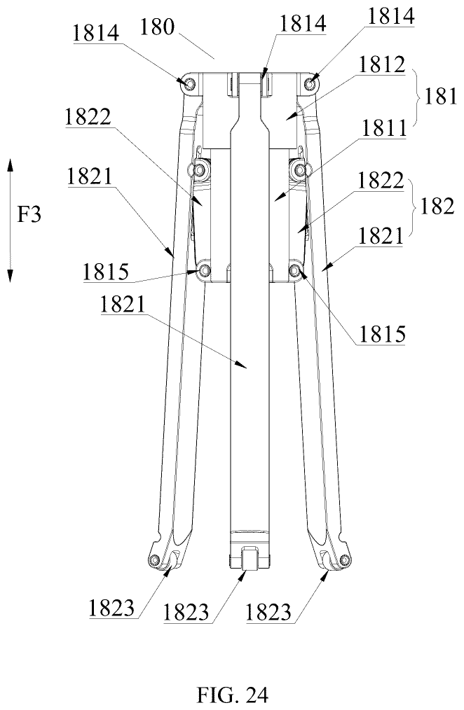

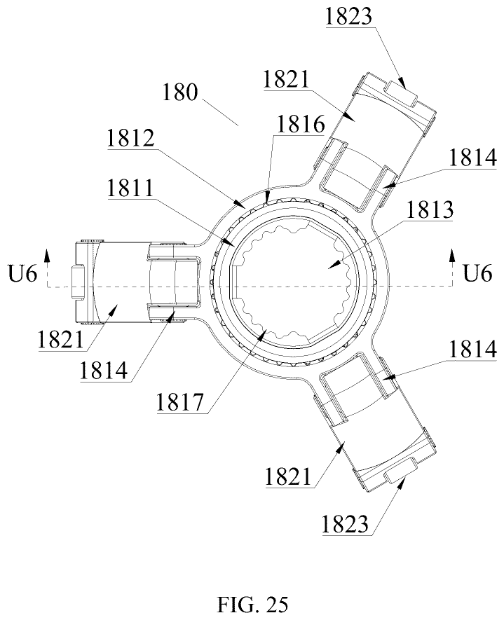

Referring to FIGS. 24 and 25, in an embodiment, the mounting assembly 181 includes a mounting cylinder 1811 and a sliding sleeve 1812. A mounting channel 1813 is formed in the mounting cylinder 1811. The pole assembly 110 (see FIG. 14) is mounted into the mounting channel 1813. Specifically, the pole assembly 110 may be directly inserted into the mounting channel 1813 to achieve the connection between the pole assembly 110 and the mounting channel 1813. In another embodiment, the pole assembly 110 may be mounted in the mounting channel 1813 by other means. For example, an inner wall of the mounting channel 1813 is provided with a female thread, the pole assembly 110 is provided with a male thread, so that the mounting channel 1813 can be threadedly connected to the pole assembly 110. Alternatively, a first engaging element is disposed inside the mounting channel 1813, the pole assembly 110 is provided with a second engaging element, so that the first engaging element can be engaged with the second engaging element.

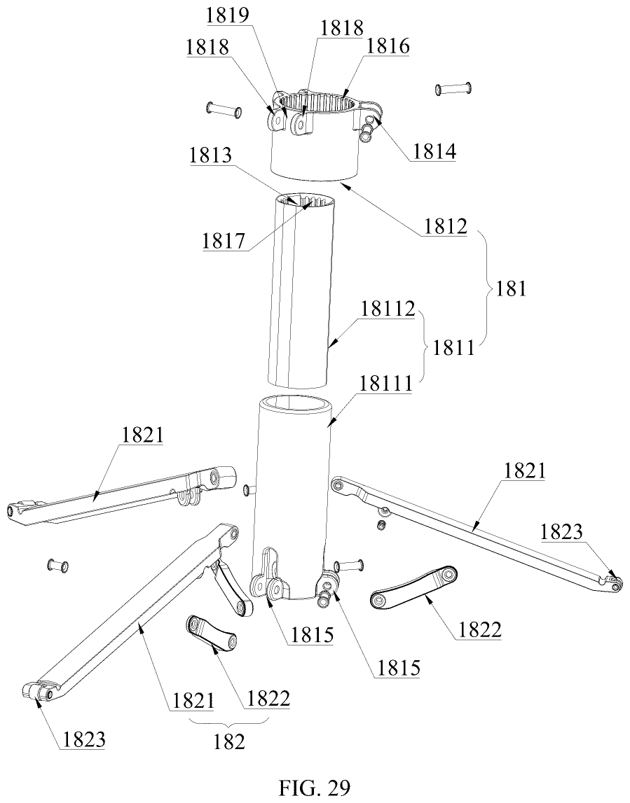

Referring to FIG. 29, in an embodiment, the mounting cylinder 1811 includes a first cylinder 18111 and a second cylinder 18112. The first cylinder 18111 is sleeved outside the second cylinder 18112 to enhance overall structural strength of the mounting cylinder 1811. More specifically, the second cylinder 18112 is provided with the mounting channel 1813.

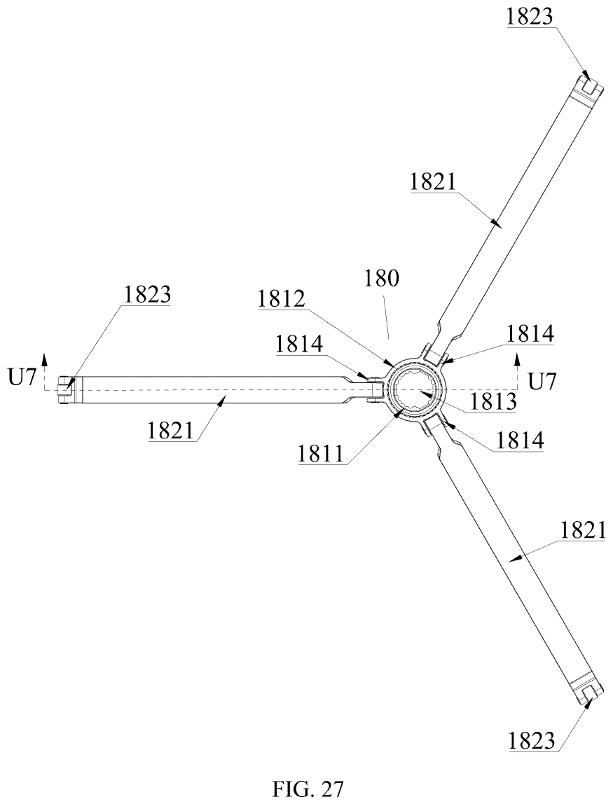

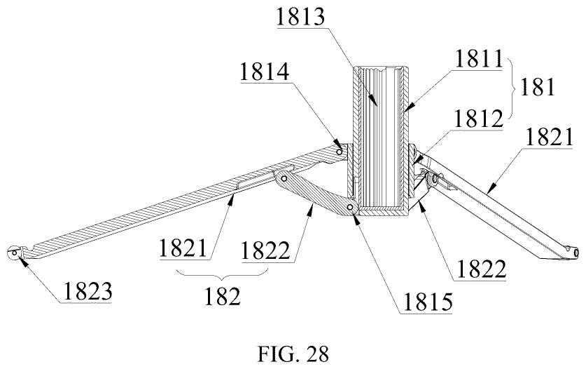

Further, as shown in FIGS. 24 and 25, the sliding sleeve 1812 is movably sleeved outside the mounting cylinder 1811 and has a third position and a fourth position. The support foot assembly 182 includes a main support foot 1821 and an auxiliary support foot 1822. An outer wall of the sliding sleeve 1812 is provided with a third hinged portion 1814. The third hinged portion 1814 is configured to be hinged to the main support foot 1821. The outer wall of the mounting cylinder 1811 is provided with a fourth hinged portion 1815. Ends of the auxiliary support foot 1822 are hinged to the main support foot 1821 and the fourth hinged portion 1815 respectively. As shown in FIGS. 27 and 28, when the sliding sleeve 1812 is in the third position, the support foot assembly 182 is in the extended state. As shown in FIGS. 24 to 26, when the sliding sleeve 1812 is in the fourth position, the support foot assembly 182 is in the collapsed state.

Referring to FIGS. 25 and 29, in an embodiment, an inner wall of the sliding sleeve 1812 is formed with a second avoidance groove 1816. The second avoidance groove 1816 extends in the length direction of the sliding sleeve 1812. If the mounting cylinder 1811 is partially deformed, for example, is formed with a bump thereon, the second avoidance groove 1816 can pass over the bump without affecting the movement of the sliding sleeve 1812. More specifically, an inner wall of the mounting channel 1813 is formed with a third avoidance groove 1817. The third avoidance groove 1817 extends in the length direction of the mounting channel 1813. If the pole assembly 110 is partially deformed, for example, formed with a bump thereon, the third avoidance groove 1817 can pass over the bump without affecting the insertion of the pole assembly 110 into the mounting channel 1813 to achieve the connection between the pole assembly 110 and the mounting assembly 181.

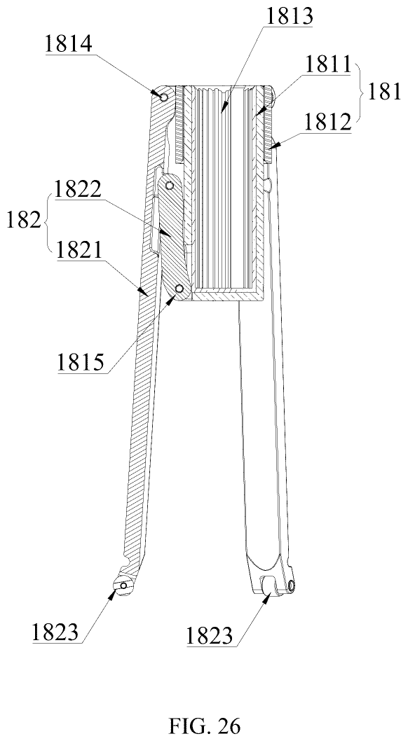

Referring to FIGS. 26 and 27, in an embodiment, at least two support foot assemblies 182 are provided. The at least two support foot assemblies 182 are provided along a circumference of the mounting assembly 181 at equal spacing. Specifically, in this embodiment, three support foot assemblies 182 are provided, the sliding sleeve 1812 is correspondingly provided with three third hinged portions 1814. The three third hinged portions 1814 are provided along a circumference of the sliding sleeve 1812 at equal spacing. Similarly, the mounting cylinder 1811 is correspondingly provided with three fourth hinged portions 1815. The three fourth hinged portions 1815 are provided along a circumference of the mounting cylinder 1811 at equal spacing, so that the mounting assembly 181 can be more stably placed on the ground to support the pole assembly 110.

In this embodiment, as shown in FIG. 29, the third hinged portions 1814 and the fourth hinged portions 1815 have the same structure. The configuration of one of the third hinged portions 1814 is specifically described below as an example. Specifically, the third hinged portion 1814 includes two connecting lugs 1818 disposed in parallel, and a second insertion groove 1819 is formed between the two connecting lugs 1818. An end of the support arm 130 is inserted in the second insertion groove 1819 and hinged to the two connecting lugs 1818.

As shown in FIG. 24, when the above bottom support mechanism 180 is used, i.e., when the support foot assembly 182 is switched from the collapsed state to the extended state, the sliding sleeve 1812 moves downward in the third direction F3 on the mounting cylinder 1811 under gravity, and drives each of the auxiliary support foots 1822 to rotate around the corresponding fourth hinged portion 1815 in a direction away from the mounting assembly 181. Meanwhile, the rotation of each auxiliary support foot 1822 drives the corresponding main support foot 1821 to rotate around the third hinged portion 1814 in the direction away from the mounting assembly 181, so that each main support foot 1821 extends, and therefore the support foot assembly 182 is in the extended state to stably support the pole assembly 110. In another embodiment, the user may push the sliding sleeve 1812 downward in the third direction F3, so that the sliding sleeve 1812 pushes each auxiliary support foot 1822 to rotate around the corresponding fourth hinged portion 1815 in the direction away from the mounting assembly 181. Specifically, when the support foot assembly 182 is in the extended state, a stable triangular structure can be formed by the main support foot 1821, the auxiliary support foot 1822 and the mounting assembly 181 (see FIG. 28), so as to avoid a random rotation of the main support foot 1821, thereby improving support stability of the main support foot 1821. The third direction F3 is parallel the vertical direction. When the above bottom support structure needs to be folded, i.e., when the support foot assembly 182 is switched from the extended state to the collapsed state, the sliding sleeve 1812 is manually pushed to cause the sliding sleeve 1812 to move upward in the third direction F3 on the mounting cylinder 1811. During the movement of the sliding sleeve 1812, the sliding sleeve 1812 drives each main support foot 1821 rotates around the corresponding third hinged portion 1814 in a direction approaching the fourth hinged portion 1815 of the mounting assembly 181, and then each auxiliary support foot 1822 rotates around the corresponding fourth hinged portion 1815 in a direction approaching the third hinged portion 1814 of the mounting assembly 181, so that each main support foot 1821 is folded to reduce a volume of the bottom support frame 180. When the support foot assembly 182 is in the collapsed state, the length direction of the main support foot 1821 and the length direction of the auxiliary support foot 1822 are approximately parallel to the length direction of the mounting assembly 181, and the auxiliary support foot 1822 is located between the main support foot 1821 and the mounting assembly 181.

Referring to FIG. 26, in an embodiment, the support foot assembly 182 further includes a caster 1823. The caster 1823 is disposed at an end of the main support foot 1821 away from the third hinged portion 1814.

An embodiment of the present application further provides a decorative tree 1000, including a decoration 30 and the tree stand 10 as described in any one of the above embodiments. The decoration 30 is supported on the pole assembly 110 and the support arms 130.

The above tree stand 10 and the above decorative tree 1000 have at least the following advantages.

The tree stand 10 according to the present application allows the support arms 130 to have the unfolded state and the folded state by hinging the support arms 130 to the support mechanism 120, so that the overall volume of the tree stand 10 can be changed. In this way, the support arms 130 can be maintained in the folded state to reduce the overall volume of the tree stand 10, thereby saving the space during storage and transportation. In addition, the first locking mechanism 150 can keep the support arms 130 stably in the unfolded state, preventing the support arms 130 from being folded by external force to affect the normal use. The tree stand is capable of being folded to reduce its volume, which in turn facilitates saving space during storing and transporting the decorative tree.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present application, and their description is specific and detailed, but cannot therefore be understood as a limitation on the patent scope of this application. It should be noted that those of ordinary skill in the art may further make variants and improvements without departing from the conception of the present application, and these all fall within the protection scope of the present application. Therefore, the patent protection scope of the present application shall be subject to the appended claims.

1-30. (canceled)

31. A tree stand, comprising:
a pole assembly,
support arms connected to a bottom end of the pole assembly and configured to be connected to a bottom of a decorative mesh,
a first mounting member mounted on a top end of the pole assembly and comprising a locking portion, and
a second mounting member movably disposed on the pole assembly and configured to be connected to a top of the decorative mesh, wherein the second mounting member comprising an engaging portion configured to be engaged with the locking portion to limit a movement of the second mounting member relative to the pole assembly.

32. The tree stand according to claim 31, wherein one of the locking portion and the engaging portion is a limiting protrusion, and another of the locking portion and the engaging portion is a limiting groove; the limiting groove is curved, and two ends of the limiting groove form a starting end and a locking end respectively,
wherein the second mounting member is movably sleeved on the pole assembly; and the first mounting member is rotatable relative to the second mounting member to enable the limiting protrusion to reciprocate between the starting end and the locking end; and the first mounting member is fixed relative to the second mounting member when the limiting protrusion is engaged at the locking end.

33. The tree stand according to claim 32, wherein the starting end extends through an end face of the second mounting member facing the first mounting member,
a sidewall of the limiting groove is provided with an engaging protrusion; and the engaging protrusion is located at the locking end and configured to abut against the limiting protrusion to limit the limiting protrusion to the locking end.

34. The tree stand according to claim 31, wherein the second mounting member comprises a locking sleeve and a connecting base connected to each other; the engaging portion is disposed on the locking sleeve; and the connecting base comprises a connecting portion configured to be connected to the top of the decorative mesh.

35. The tree stand according to claim 34, wherein the engaging portion is a limiting groove at least extending through an outer side surface of the locking sleeve,
the locking portion is a limiting protrusion, a side of the first mounting member facing the second mounting member is provided with a rotation hole; and the limiting protrusion is disposed on an inner wall of the rotation hole,
wherein at least a portion of the locking sleeve is received in the rotation hole, and is connected to the first mounting member by a cooperation between the limiting protrusion and the limiting groove.

36. The tree stand according to claim 31, wherein the first mounting member is located at the top end of the pole assembly and is movable in a length direction of the pole assembly relative to the pole assembly.

37. The tree stand according to claim 36, wherein the top end of the pole assembly is provided with a support cylinder, wherein the support cylinder is provided with a coupling hole in communication with an inner cavity of the support cylinder,
and the first mounting member is provided with a guide post, wherein the guide post extends through the coupling hole and is at least partially limited in the inner cavity of the support cylinder.

38. The tree stand according to claim 37, wherein the inner cavity of the support cylinder is provided with a stop block, wherein the stop block is detachably connected to the guide post, and stopped by a bottom wall of the inner cavity of the support cylinder to limit at least a part of the first mounting member in the support cylinder.

39. The tree stand according to claim 31, further comprising an elastic member disposed between the first mounting member and the pole assembly,
wherein the elastic member is configured to provide elastic force that enables the first mounting member to move away from the bottom end of the pole assembly.

40. The tree stand according to claim 39, wherein a side of the first mounting member facing the second mounting member is provided with a rotation hole; a bottom wall of the rotation hole is provided with a guide post,
the top end of the pole assembly is provided with a support cylinder having a coupling hole, wherein the guide post is movably inserted into the coupling hole, and the elastic member is sleeved on the guide post, and two ends of the elastic member are located between the coupling hole and the bottom wall of the rotation hole, and abuts against the support cylinder and the bottom wall of the rotating hole respectively.

41. The tree stand according to claim 40, the pole assembly comprising:
a fixed support tube assembly connected to the support arms, and
a movable support tube assembly connected to the first mounting member,
wherein the movable support tube assembly is detachably connected to the fixed support tube assembly, or
the movable support tube assembly is telescopically connected to the fixed support tube assembly.

42. The tree stand according to claim 41, wherein at least one of the fixed support tube assembly and the movable support tube assembly comprises at least two support tubes, the at least two support tubes being detachably connected or telescopically connected.

43. A tree stand, comprising:
a support base fixed on the pole assembly,
wherein an end of each support arm is hinged to the support base to allow the support arm to switch between an unfolded state and a folded state, and another end of each support arm is configured to be connected to the decorative mesh.

44. The tree stand according to claim 43, further comprising:
a movable base movably disposed on the pole assembly and connected to the support arms to drive the support arms to switch between the unfolded state and the folded state, and a first locking mechanism disposed on the movable base and having a locked state and an unlocked state,
wherein when the first locking mechanism is in the locked state, the movable base is limited from moving relative to the pole assembly to keep the support arms in the unfolded state or the folded state, and when the first locking mechanism is in the unlocked state, the movable base is allowed to move relative to the pole assembly to allow the support arms to switch between the unfolded state and the folded state.

45. The tree stand according to claim 44, wherein the pole assembly is provided with at least one locking recess, and the first locking mechanism comprises a locking member disposed on the movable base and movable in a first direction,
wherein when the first locking mechanism is in the locked state, the locking member extends into one of the at least one locking recess to limit the movable base from moving relative to the pole assembly, and when the first locking mechanism is in the unlocked state, the locking member withdraws from the one of the at least one locking recess to allow the movable base to move relative to the pole assembly.

46. The tree stand according to claim 45, wherein the first locking mechanism further comprises a first reset member abutting against the locking member bias the locking member to move from an unlocked position to a locked position.

47. The tree stand according to claim 46, wherein the movable base comprises:
a through channel;
a receiving cavity; and
a through hole in communication with the receiving cavity and the through channel,
wherein the movable base is sleeved on the pole assembly through the through channel; the first reset member is disposed in the receiving cavity; at least a portion of the locking member is movably disposed in the receiving cavity; and two ends of the first reset member abut against an inner wall of the receiving cavity and the locking member respectively, to bias the locking member to move in a direction of extending out of the through hole.

48. The tree stand according to claim 47, wherein the movable base comprises an upper shell and a lower shell which are connected to each other, the through channel comprises a first channel and a second channel,
wherein the upper shell comprises an inner ring portion provided with the first channel and an outer peripheral portion surrounding the inner ring portion,
wherein the outer peripheral portion is connected to the inner ring portion, and the receiving cavity is formed between the outer peripheral portion and the inner ring portion, and the inner ring portion has the through hole,
wherein the lower shell has the second channel.

49. The tree stand according to claim 45, further comprising an unlocking mechanism comprising an unlocking member,
wherein the unlocking member is connected to the locking member and operatable to drive the locking member to move from a locked position to an unlocked position,
wherein the unlocking member has a first position and a second position, when the unlocking member is in the first position, the locking member is in the locked position, and when the unlocking member is in the second position, the locking member is in the unlocked position.

50. The tree stand according to claim 49, wherein the unlocking member is disposed on the movable base and is movable in a second direction, and when the unlocking member moves from the first position to the second position, the unlocking member drives the locking member to move from the locked position to the unlocked position in the first direction,
wherein the second direction is parallel to a radial direction of the pole assembly and not parallel to the first direction.
